(19) United States
(12) Patent Application Publication
(10) Pub. No.: US 2011/0092332 A1
(43) Pub. Date: Apr. 21, 2011

(54) COMPACT BACKDRIVE RESISTANT TRANSMISSION

(76) Inventor: Roger A. Evenson, Saint Paul, MN (US)

(21) Appl. No.: 12/990,770

(22) PCT Filed: May 1, 2009
(86) PCT No.: PCT/US09/02708

§ 371 Date: Dec. 8, 2010

Related U.S. Application Data
(60) Provisional application No. 61/050,060, filed on May 2, 2008.
(60) Provisional application No. 61/194,910, filed on Oct. 1, 2008.

(51) Int. Cl. F16H 23/00

(52) U.S. Cl. 475/168

(57) ABSTRACT

A configurable power transmitter device having an input structure, an output structure, and a torque conversion assembly. The input, output, and torque conversion assembly are arranged to rotate with respect to each other and to be contained within a housing structure. The power transmitter includes structure for transforming concentric rotational motion from the input structure into eccentric motion of the transmitting structure to concentric rotational motion of the output structure. The power transmitter device has a configuration which has anti-back drive features and which provides self-governing and self-braking capabilities operative on the output structure.

### CROSS REFERENCE TO RELATED APPLICATIONS

The present subject claims the benefit of priority under 35 USC 119(e) to U.S. Provisional Patent Application Ser. No. 61/050,060, entitled, “Configurable Power Transmitter,” filed May 2, 2008, the entire specification of which is incorporated herein in its entirety.

The present subject claims the benefit of priority under 35 USC 119(e) to U.S. Provisional Patent Application Ser. No. 61/194,910, entitled, “Compact Backdrive Resistant Transmission with Two Cams,” filed Oct. 1, 2008, the entire specification of which is incorporated herein in its entirety.

### BACKGROUND

New power transmission devices are needed to solve problems relating to power management. For example, devices that are non-back driveable are needed for safety.

Transmissions transmit torque from an input to an output while multiplying the torque transmitted using mechanical advantage. For example, in a vehicle transmission, a torque applied to an input shaft is transmitted through a device and spurs the output shaft into motion. Often, the input spins faster than the output, and the output has lower torque. These transmissions are easily backdrivable, meaning if one were to apply a torque to the output shaft, they would be able to incite motion of the input, as is demonstrated when “push starting” a vehicle.

Some applications require that the two-way transmission of torque be restricted. In other words, devices are needed that move an output when an input torque is applied to an input, but to not move the input when a torque is applied to the output. Worm drives have been used in the past to accomplish this, however these devices are not compact. The worm gear is lengthy, and the worm drive outputs motion perpendicular and offset from the input. Other devices have used brakes, which add complexity and cost to a transmission. A device that is more compact, and that is simple to manufacture and inexpensive is needed. A device that can be optionally configured to output torque along a shaft that is coaxial with an input shaft is also desired.

### SUMMARY

The present subject matter relates to a power transmitting device. More particularly, it relates to a cycloidal planetary drive. The power drive utilizes unique geometries and relationships to provide great latitude in the arrangement, form, positioning and use of its components. Therefore, the components of the power drive can be arranged in many ways to pursue a given result or to obtain various results. As a torque converter, the present embodiment can multiply the torque about its axis with a corresponding reduction in the velocity of the rotation. The power drive can be configured either to allow its output to drive its input or to innately prevent its output from driving its input through the geometrical relationship and interaction of its components. The prevention of backdrivability also provides derivative self-governing and self-braking features since the output resists causing motion of the input.

Various embodiments use different structures of distinct geometries to cooperate and rotate with respect to each other. The power drive can be configured into a torque converter device that either has the characteristic of backdrivability or the characteristics of being backdrive resistant, self-governance, and self braking; that has one or multiple input elements; that has one or multiple output elements; that can have its working elements arranged radially or linearly; that can be fixedly or non-fixedly mounted; that can be configured as a pure cam system, pure gear system, or as a hybrid cam and gear system; and that has working elements that are not dependent on specific geometry. The above-mentioned examples are representative of configurability and are not intended as an exhaustive list. Since it is highly configurable, the present subject matter can be used in numerous devices including, among other things, a torque wrench, a drilling device that can drive two loads, and as part of a self-governing and self-braking drive that prevents potentially harmful back-rotation.

Prior torque converters lack the versatility offered by the unique geometrical configurations disclosed herein. Furthermore, prior torque converter devices have used orbiting eccentric members as part of a planetary drive, they invariably drive the orbiting eccentric member radially outward from the center out toward the outer periphery of the device; whereas some embodiments of the present subject matter drive an orbiting eccentric member radially inward from the outer periphery in toward the center of the device. As a result, prior drives could not be configured to inherently prevent backdrivability, nor to inherently have a self-governing and self-braking effect, without introducing an external force that would compromise the efficiency of the power conversion. Although various torque converters have been proposed and used in the past, none have been able to be used in as flexible of a manner as taught by the present subject matter.

One objective of the present subject matter is to provide an efficient power transmitter that is capable of being used for numerous tasks and in a variety of applications through simple interchange of its geometrical components. Another objective of the present subject matter is to provide an inherent power drive configuration whose components innately prevent its output from driving its input and provide self-governing and self-braking capabilities operative on its output. These and other objectives of the invention will be apparent to those skilled in this art from the following detailed description of preferred embodiments of the present subject matter.

A power drive uses unique geometry and relationships between and within an input structure, a torque conversion assembly, and an output structure. The power drive typically will have a housing structure. The torque conversion assembly includes a conversion driver assembly, a multi-mode bias, and a torque conversion translator.

A typically rotational input force is applied to the input structure and remains continuous throughout the torque conversion assembly of the power drive to produce a typically rotational force applied by the output structure. The motion of the input structure imparts eccentric motion to the conversion driver assembly. The multi-mode bias may act on the conversion driver assembly to modify its eccentric motion into one of several types of motion.

The structures may be configured in such a way as to provide a power drive whose innate geometry prevents backdrivability and provides derivative self-governing and self-braking characteristics. Numerous geometrical combinations may be used in the torque conversion assembly. All of these geometrical combinations efficiently convert an input force continuously through the torque conversion assembly into an output force. However, certain geometrical combinations in the torque conversion assembly prevent the output from driving the input by interrupting the back-driving force through its inherent geometrical configuration. In effect, the power drive can be configured to be the mechanical equivalent of an electronic diode, a device that allows electrical current to flow in one direction only.

The ability of certain configurations to interrupt a back-driving force in the torque conversion assembly results from the general arrangements of the components. The input structure transmits the input force in a generally radially inward way to the torque conversion assembly. Furthermore, certain combinations of geometrical forms used in the driver, the translator, and the bias generator interact upon the exertion of a back drive force to produce a resultant force incapable of motion in the input structure as long as the back drive force is within the load limits of the power drive.

Unlike prior designs, the geometric relationships of various embodiments can be easily configured for many applications, including an inherent drive configuration that has non-backdriving, self-governing and self-braking capabilities. Thus the power drive is an efficient and flexible power converter that is capable of preventing potentially harmful back-rotation to motors, conveyor systems, and the like.

### BRIEF DESCRIPTION OF THE DRAWINGS

FIG. 1 is an exploded view of the second embodiment of the power transmitter.

FIG. 2 is a partially exploded view of the embodiment of FIG. 1 showing the assembled input structure, output structure, and transmitting structure.

FIG. 3A is a front view of the drive of FIG. 2.

FIG. 3B is a side view of the drive of FIG. 2.

FIG. 4A is cross section taken along line 4A-4A in FIG. 3A.

FIG. 4B is cross section taken along line 4B-4B in FIG. 3A.

FIG. 5A is cross section taken along line 5A-5A in FIG. 3B.

FIG. 5B is cross section taken along line 5B-5B in FIG. 3B.

FIG. 6 is a cross section taken along line 6-6 of FIG. 3B.

FIG. 7 is an exploded view of a fourth embodiment of the power transmitter.

FIG. 8A is the output and side views of the power transmitter of FIG. 7.

FIG. 8B is the side view of the power transmitter of FIG. 7.

FIG. 9A are the cross-sectional views taken along line E-E and line D-D of FIG. 8A.

FIG. 9B is a cross section view taken along 9B-9B in FIG.

FIG. 10A is the cross-sectional view taken along line A-A of FIG. 8A.

FIG. 10B is the cross-sectional view taken along line B-B of FIG. 8A

FIG. 11 is a cross-sectional view taken along line C-C of FIG. 8A.

FIG. 12A shows a back view of the input cam portion of the power transmitters of FIGS. 2 and 7.

FIG. 12B shows a cross sectioned side view of the input cam portion of the power transmitters of FIGS. 2 and 7.

FIG. 12C shows a front view of the input cam portion of the power transmitters of FIGS. 2 and 7.

FIG. 13A shows a back view of the conversion driver host of the power transmitter of FIG. 7.

FIG. 13B shows a cross-sectioned side view of the conversion driver host of the power transmitter of FIG. 7.

FIG. 13C shows a front view of the conversion driver host of the power transmitter of FIG. 7.

FIG. 14 shows an exploded view of a drive, according to one embodiment.

FIG. 15 shows a general cycloidal relationship between a multi-cardioid cam and rollers, and between rollers and a multi-lobe hypo-cardioid cam and it shows the cycloidal-pulsed orbital bias motion of the rollers.

FIG. 16A shows an inverted multi-cardioid cam, according to some embodiments.

FIG. 16B shows an followers slidably disposed in a center rotor, according to some embodiments.

FIG. 17 shows an example of a power transmitter in a static bias mode.

FIG. 18A shows a back view of the bias generator host that is exchanged with the bias generator host of the third embodiment that transforms the orbital motion of the third embodiment into the cycloidal pulsed orbital motion of the fifth embodiment.

FIG. 18B shows a cross-sectioned side view of the bias generator host that is exchanged with the bias generator host of the third embodiment that transforms the orbital motion of the third embodiment into the cycloidal pulsed orbital motion of the fifth embodiment.

FIG. 18C shows a front view of the bias generator host that is exchanged with the bias generator host of the third embodiment that transforms the orbital motion of the third embodiment into the cycloidal pulsed orbital motion of the fifth embodiment.

FIG. 19 shows an exploded view of the sixth embodiment of the power transmitter.

FIG. 20 is a perspective view of the planar inverted cardioid cam form used within the seventh embodiment of the power transmitter.

FIG. 21 is a perspective view of the planar hypo cardioid cam form used within the seventh embodiment.

FIG. 22A shows a perspective view of the planar input structure used within the seventh embodiment.

FIG. 22B shows a side view of the planar input structure used within the seventh embodiment.

FIG. 23 shows a cross-sectional view of the first embodiment

FIG. 24 is a sectional view of the inverted cardioid cam.

FIG. 25 is a cutaway view showing tF14 and 28 he hypo-cardioid cam.

FIG. 26A shows a multi-lobe cycloidal cam or hypocardioid cam.

FIG. 26B shows an inverted multi-cardioid cam.

FIG. 27 is a drawing similar to FIG. 24 except showing a 2:1 ratio between the input and the output.

FIG. 28 is a cross section of the embodiment disclosed in FIG. 29.

FIG. 29 is a diagram of a transmission, according to some embodiments.

FIG. 30A is an isometric view of a cross section of a transmission, according to some embodiments.

FIG. 30B is an isometric view taken along line 2B-2B in FIG. 2A.

FIG. 30C is an isometric view taken along line 2C-2C in FIG. 2A.

FIG. 31 is a perspective view of a carrier and a pinion coupled at a geared interface, according to some embodiments.

FIG. 32 is a perspective view of a housing, according to some embodiments.

FIG. 33A is a perspective view of an input, according to some embodiments.

FIG. 33B is a further perspective view of an input, according to some embodiments.

FIG. 34A is a perspective view of a carrier, according to some embodiments.

FIG. 34B is a further perspective view of a carrier, according to some embodiments.

FIG. 35 is a perspective view of rollers to be disposed in sockets of a carrier, according to some embodiments.

FIG. 36 illustrates a perspective view of an output and an optional coupler, according to some embodiments.

FIG. 37 illustrates a perspective view of a lid for a housing and a housing pinion, according to some embodiments.

FIG. 38 is a perspective view of a cross section of a bearing system to be installed in a transmission, according to some embodiments.

### DESCRIPTION OF THE EMBODIMENTS

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Various embodiments have an input structure 200 constructed and arranged to be used as an input drive member, an output structure 700 constructed and arranged to be used as an output drive member, and a torque conversion assembly 300. In addition, embodiments show a power drive whose elements are simply constructed and arranged in such a manner as to provide an efficient and versatile cycloidal drive.

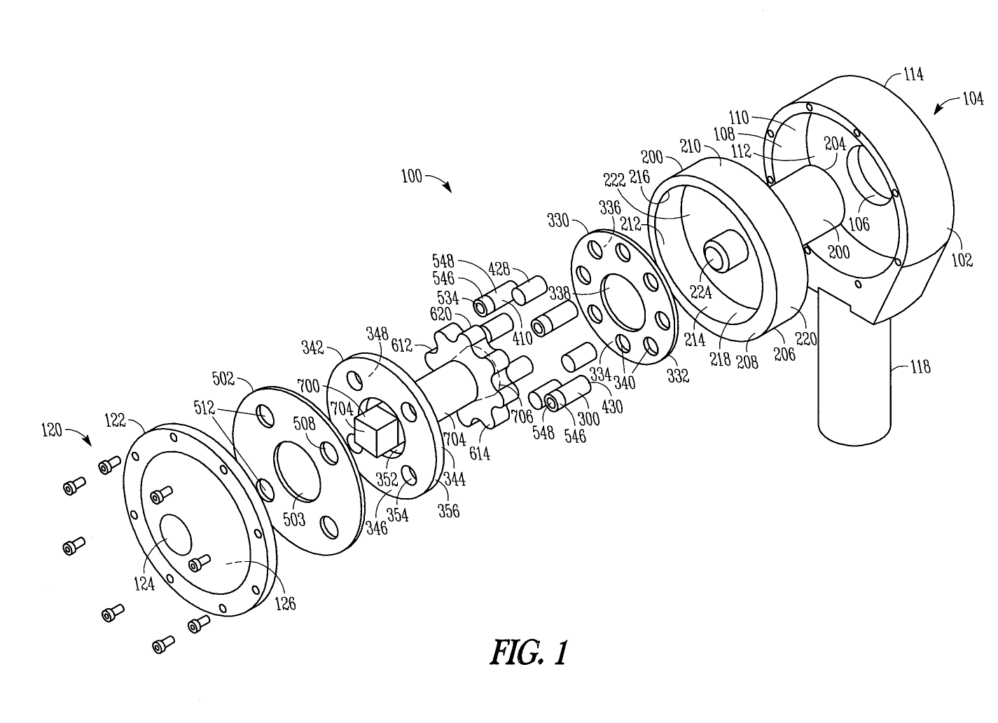

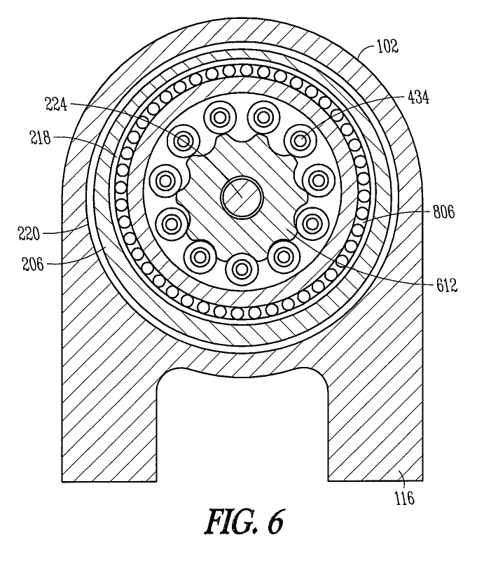

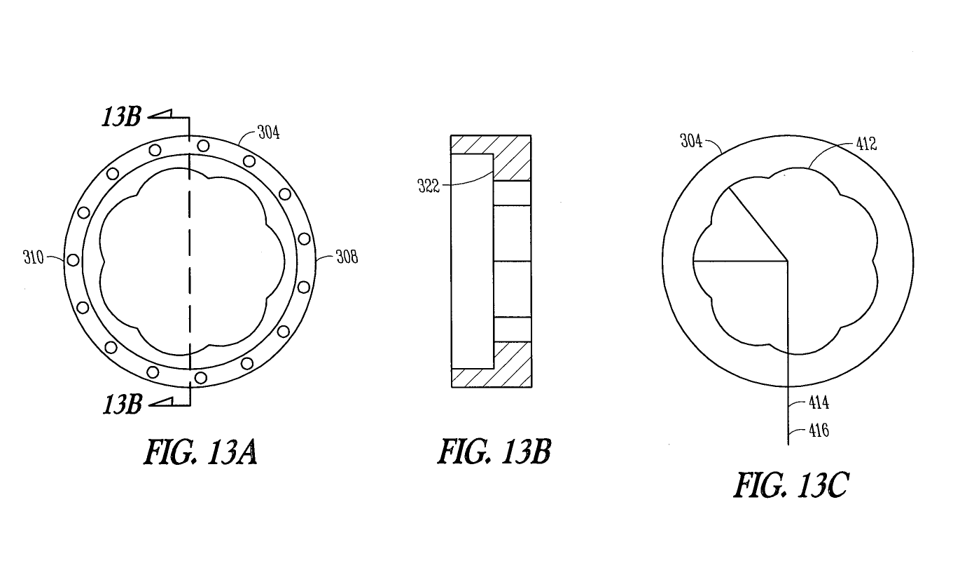

Various embodiments show the input structure 200, torque conversion assembly 300, and output structure 700 constructed and functionally arranged within a housing structure 100. The main body of housing 102 has an input end 104, a body cavity 108, and an output end 120. The input end 104 of the main body 102 is constructed and arranged to have an input shaft aperture 106 sized and located to receive an input shaft portion 204 of the input structure 200 through the housing structure 100. The body cavity 108 contains most of the input structure 200, torque conversion assembly 300, and output structure 700. The output end 120 of the main body of housing 102 has a front cover 122 fixedly attached to the main body 102. The front cover 122 is constructed and arranged to have an output shaft aperture 124 sized and located to receive an output shaft portion 124 through the front cover 122 of the housing structure 100. As shown in FIG. 1, a handle member 118 may be integrally formed with the main body of housing 102. As shown in FIGS. 6 and 13, housing flanges 116 may form an integral part of the main body of housing 102 in a manner that allows the power drive to be fixated to a support. Although the housing structure 100 is typically a passive device for holding the elements, the housing structure 100 may take an active form to drive a load. For example, a dual drilling device could use its housing structure 100 and output structure 700 to drive two loads simultaneously.

In some embodiments, the input structure 200 is a concentric input shaft portion 204 and an input cam portion 206. The input shaft portion 204 is a concentric protrusion that extends from within the housing structure 100 and provides means for introducing a concentric rotational force to the power drive. The input cam portion 206 is a cup-shaped element having a perpendicular face 208, an eccentric interior axial wall 218, and a concentric exterior axial wall 220. The eccentric interior axial wall 218 and perpendicular face 208 form a cavity 214. The input structure 200 typically contains an input shaft extension 224 that is used as means to provide support and rigidity to the output structure 700.

The motion of the input structure 200 is typically rotational. The input structure 200 converts a rotational input motion into the orbital motion of subsequent elements of the power drive. The eccentric interior cam portion 216 transforms the concentric and rotational force imparted to the input shaft portion 204 and the input cam portion 206 into the eccentric, orbital motion of the torque conversion assembly 300. The motion of the torque conversion assembly 300 may be further modified by the multi-mode bias 500 of the torque conversion assembly 300. The input cam portion 206, the eccentric interior cam portion 216, and the torque conversion assembly 300 are constructed and arranged in a manner that the input structure 200 drives the torque conversion assembly 300 with a radially inward force from the periphery in toward the center of the power drive.

The torque conversion assembly 300 is located within the cavity 214 of the input structure 200. In all embodiments, the torque conversion assembly 300 has a conversion driver assembly 302, a multi-mode bias 500, and a conversion translator 600 may take differing forms and arrangements to accommodate design considerations such as diametric or linear dimension constraints, economics, and high precision requirements. The conversion driver assembly 302 includes a conversion driver host 304 and a conversion driver 400. The torque conversion and speed reduction process begins in the conversion driver assembly 302.

The multi-mode bias 500 of the torque conversion assembly 300 contains a bias generator host 502 and a bias relay assembly 530 that serves as the interface between the bias generator host 502 and the conversion driver host 304. The multi-mode bias 500 influences the motion of the conversion driver host 304 and the conversion driver 400. The multi-mode bias 500 cooperates with the eccentric interior cam portion 216 of the input structure 200 to generate one of the following three modes of bias in the conversion driver assembly 302: (1) static bias mode, (2) orbital bias mode, or (3) cycloidal-pulsed orbital bias mode.

The conversion driver 400 drives the conversion translator 600. The translator 600 and driver 400 typically have a cycloidal relationship. As evidenced in the embodiments and as will be discussed below, the driver 400 and translator 600 may function with several different combinations of geometrical shapes, including cams, gears, and hybrid shapes having both cams and gears.

The ability of the power drive to operate in different bias modes to produce the three types of motion in the conversion driver assembly 302 using different forms provides its versatility for use in numerous applications.

The output structure 700 contains an output shaft portion 704. The output structure 700 is typically incorporated as part of, or is coupled to, the translator 600 of the torque conversion assembly 300. The output shaft portion 704 typically has a concentric cavity 706. The input shaft extension 224 fits within the concentric cavity 706 to provide means of support and rigidity to the output structure 700.

Some described motions, actions, and interactions shall be construed as occurring during one full, 360° rotation of the input structure 200. References for 0° position 308 and 180° position 310 are indicated on the FIGS. as may be appropriate.

The power drive is in its “zero position” when a straight line can be drawn on the horizontal axis 807 through a translator's rotational center 602 and a driver roller's rotational center 402, or through the driver form's 0° position 812 to the input cam perpendicular face's 0° position 216, or through the driver host's 0° position 308. The linear axis of the power drive which passes through the rotational center of the input 202 and output 702 structures shall serve as the primary reference.

The basic operation of the power drive as demonstrated in the embodiments described below include:
a) A pure rotational input force is applied to the input shaft portion 204 of the input structure 200.
b) The eccentric interior cam portion 216 of the input structure 200 converts the rotational motion of the input force and imparts an eccentric, orbital motion to the conversion driver assembly 302.
c) The multi-mode bias 500 influences the eccentric, orbital motion of the conversion driver assembly 302. Thus the eccentric interior cam portion 216 and the multi-mode bias 500 combine to cause one of the three bias modes in the driver assembly 302. The type of mode depends on which one of multiple bias generator forms 504, 516, 518, 524 are used in the multi-mode bias 500.
d) The motion of the driver 400 within the driver assembly 302 is influenced by the input structure 200 and the multi-mode bias 500. The driver 400 interacts with the translator 600 which may be operationally connected to the output shaft 704 in such a way so that the torque about the output shaft 704 is greater than the applied torque about the input shaft portion 204 and the rotational velocity of the output shaft portion 704 is less than the rotational velocity of the input shaft 204.

In the first embodiment, the drivers 400 are driven independent from the driver host 304. In the second, third, fourth, fifth and sixth embodiments, one complete 360° rotation of the input structure 200 results in one complete 360° orbit of the driver host 304. The driver 400 and translator 600 typically have a relationship where one will have one more reacting surface (e.g., driver roller 404 or cam lobe 422). This difference in reacting surfaces determines the ratio of torque multiplication and velocity reduction in the power drive. A larger number of reaction surfaces will increase torque multiplication and velocity reduction ratio. For example, the relationship of eight driver rollers 404 to seven translator cam lobes 614 found in the second embodiment results in a velocity reduction between the input structure 200 and output structure 700 of seven to one because seven complete rotations of the input structure 200 are required to effect seven complete orbits of the drivers 400 and one complete rotation of the translator 600.

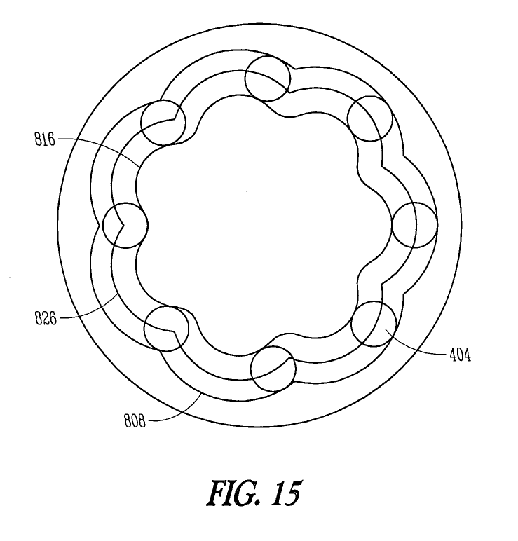

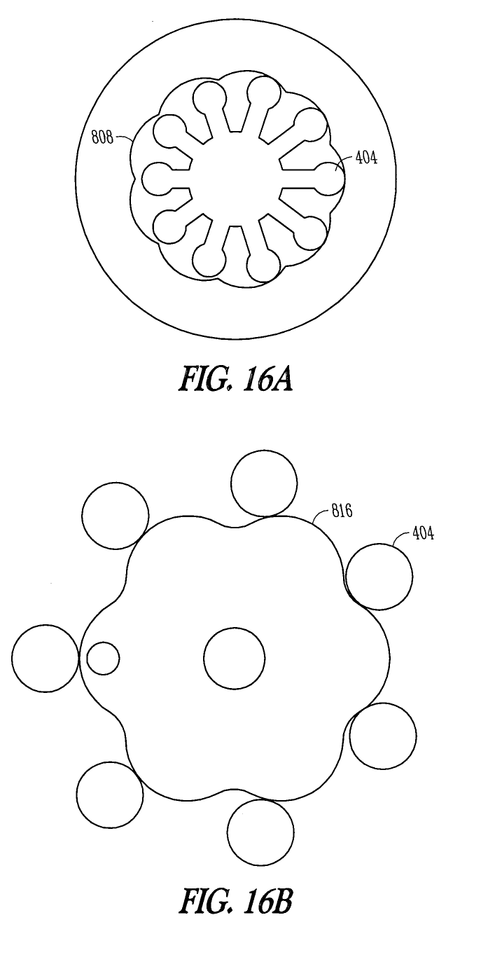

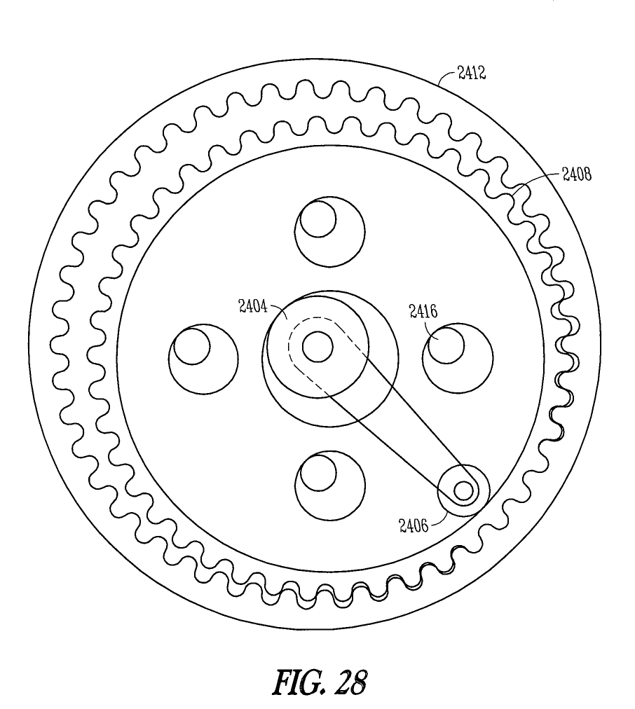

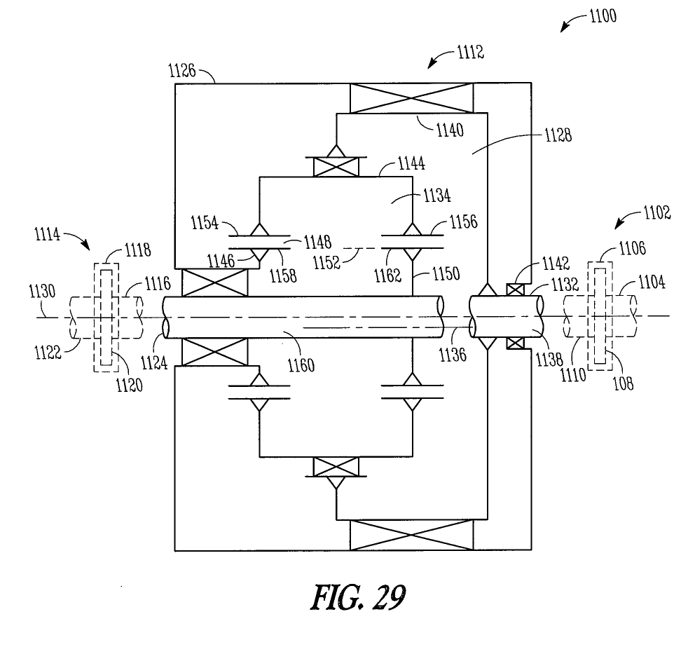

This relationship between reacting surfaces extends throughout the torque conversion assembly 300. Where the number of rollers found within the driver 400, translator 600, or bias relay 530 is one more than the number of inverted cardioids 810 or hypocardioids 818 found in an inverted multi-cardioid cam 808 or hypocardioid cam 816, the device will operate as described in the previous paragraph. If the rollers are assumed to be the driver 400 and are in a clockwise orbit, the translator 600 will make one complete 360° counter clockwise rotation for every seven complete 360° clockwise rotations of the input structure 200. However, if the inverted multi-cardioid cam form 808 (FIGS. 15A, 16A, 24, 26B, which have seven or 9 inverted cardioids 810, respectively) is assumed to be the driver 400 and is in a clockwise orbit, and the eight rollers 404 are assumed to be the translator 600, eight complete 360° orbits of the driver 400 will result in one complete 360° clockwise orbit of the translator 600. The torque reduction of the driver host 304 of the torque conversion assembly 300 is complementary to the torque reduction for the output structure 700 because the actual torque reduction for each member depends on the relative loads placed on each member. Therefore, the power drive can function as a differential drive or can drive two different size loads as in the dual drilling device. On various embodiments, the rollers 414 follow the roller centerline path 826 which is a path traced by the centerline of the rollers 404. In FIG. 16A, the rollers 404 are coupled to a piston 9000 which is slidably disposed in a rotor 9002.

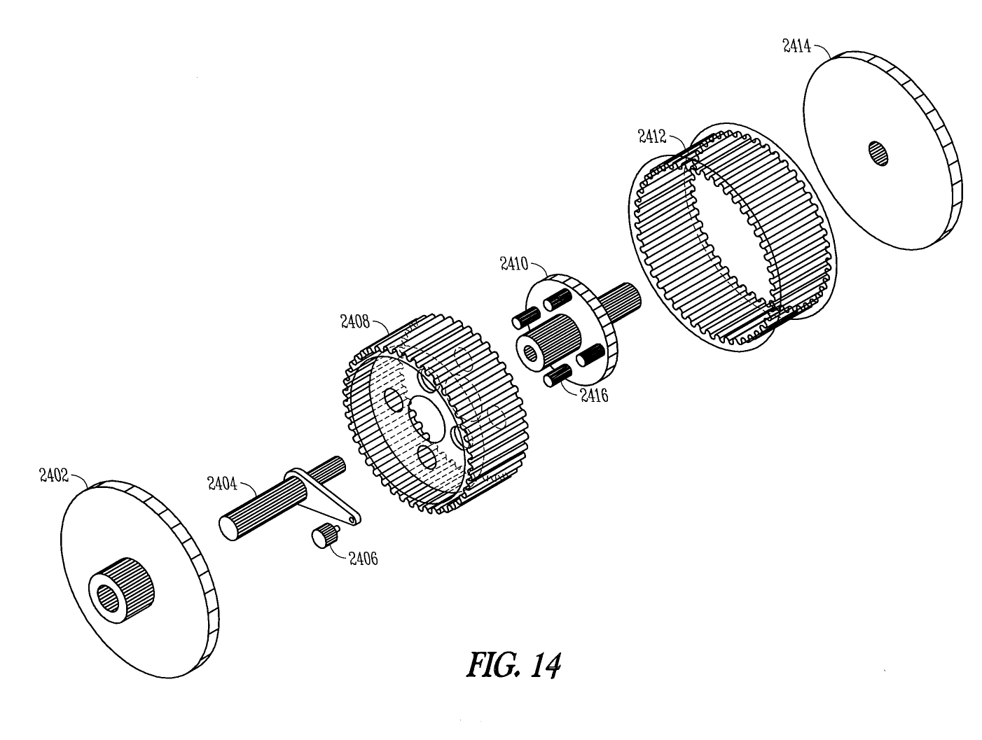

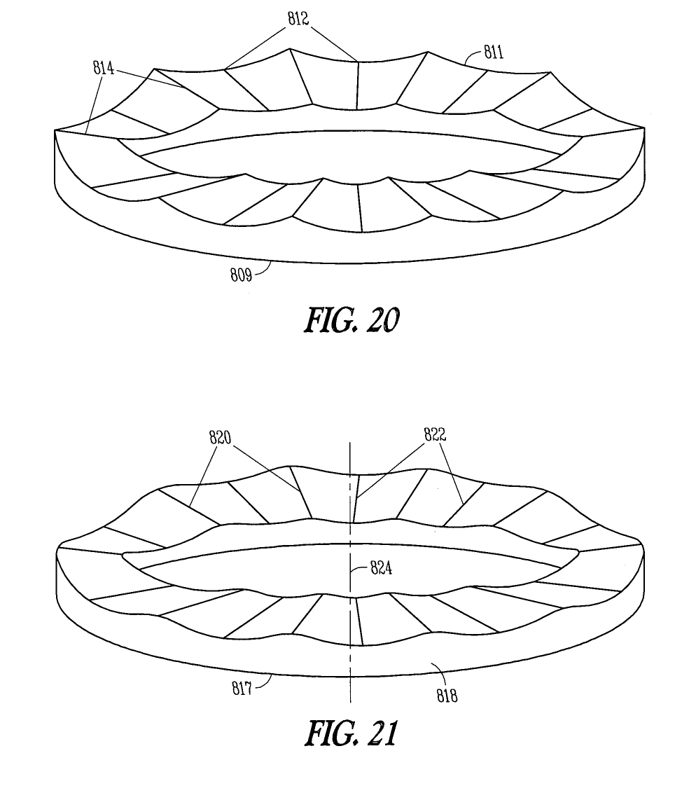

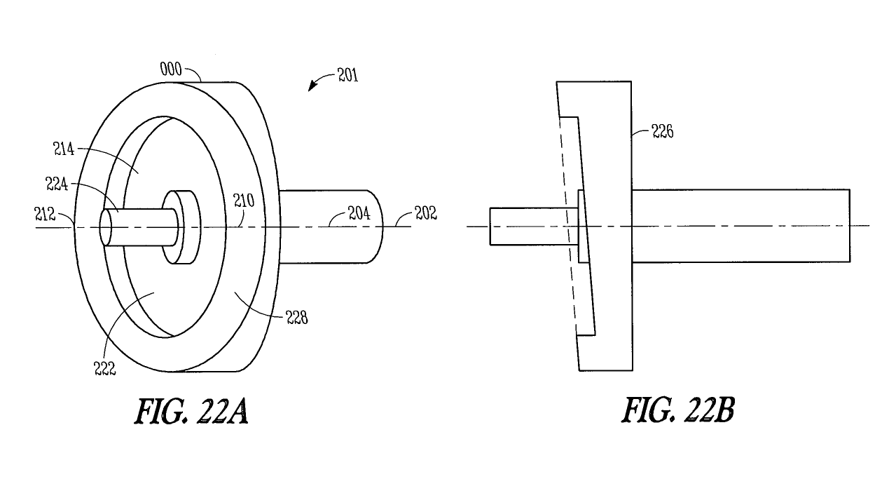

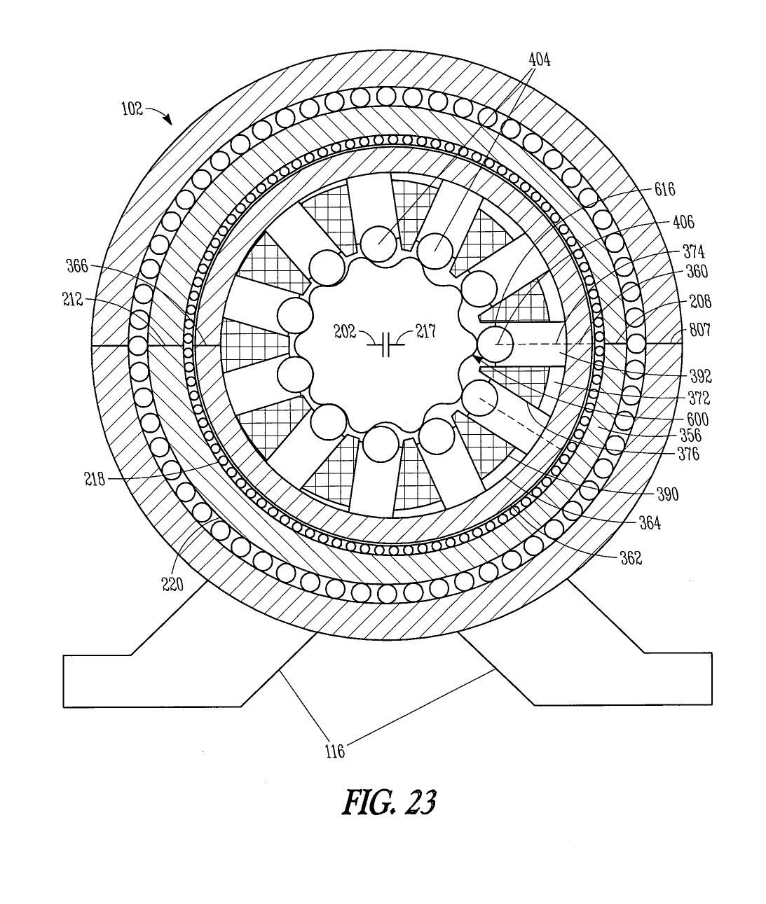

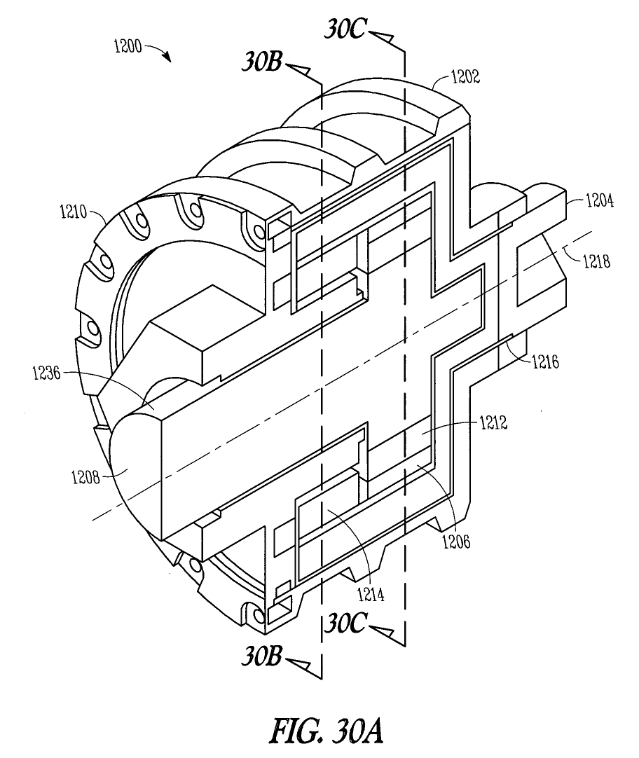

It as anticipated that the inverted cardioid form 810 or hypo-cardioid form 818 can be a geared form. One embodiment is illustrated in FIGS. 14 and 28, but the present subject matter is not so limited. Furthermore, a planar form of the mechanism is anticipated in which the input cam, driver or translator rollers, driver or translator cam forms may be constructed on the plane perpendicular to the rotational axis of the power drive. This planar form is considered the seventh embodiment of this present subject matter and is shown in FIGS. 20-22.

Much of the versatility and configurability of the power drive resides in the construction and arrangement of the torque conversion assembly 300, and specifically in the geometric relationships of the conversion driver 400, the multi-mode bias 500, and the conversion translator 600. The embodiments described below demonstrate this configurability and versatility.

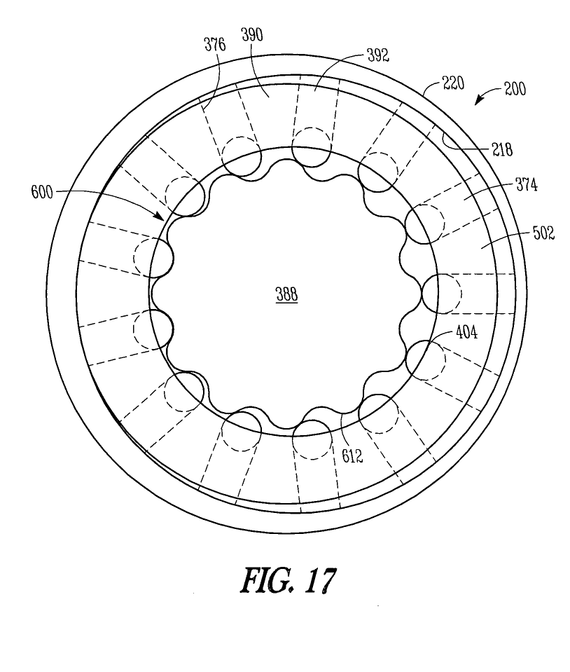

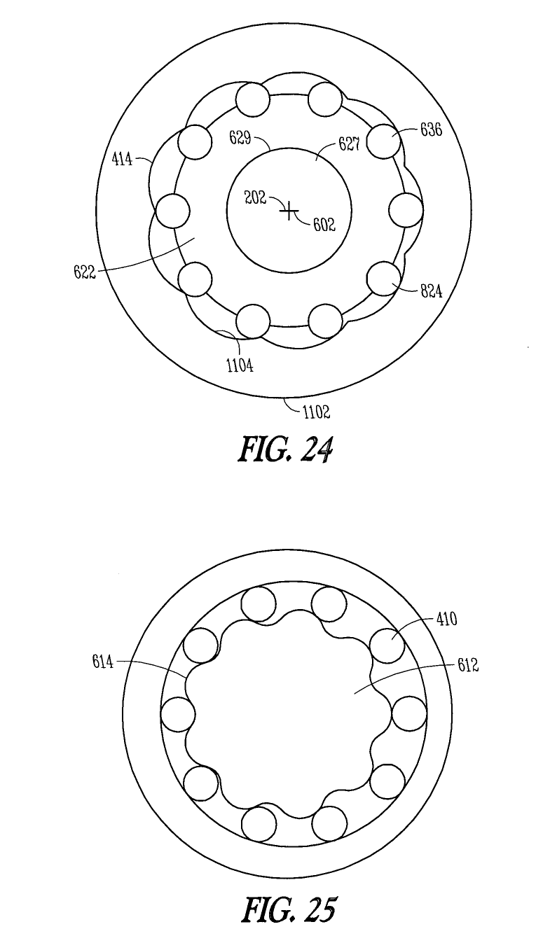

FIGS. 17 and 23 relates to a first embodiment of a transmission. In the first embodiment, the torque conversion assembly 300 includes a discrete conversion driver host 304. In various embodiments, conversion driver host 304 takes the form of a circular encasement having a plurality of piston slots 392 positioned radially inward from the orbiter ring 358. The torque converter assembly 300 is sized and located to permit the input shaft extension 224 to be received by a cavity 706 in the output shaft portion 704, and thus stabilize the output structure 700 by providing it with a means of support and rigidity. A plurality of driver rollers 404 are seated within a driver piston 374, which itself is seated within a piston slot 390, and form the conversion driver 400 of the torque conversion assembly 300.

The multi-mode bias 500 includes a static bias generator 516 formed within a bias generator host 502 and includes a bias relay assembly 530. The bias relay host 536 of the bias relay assembly 530 takes the form of a plate that is fixedly attached to the conversion driver host 304. The bias relay host 536 has a concentric aperture 537 sized and located to receive the output shaft portion 704 through the bias relay host 536.

The conversion translator 600 is formed by a multi-lobe cycloidal cam 612 integrally formed about the circumference of the output shaft portion 704. FIG. 23 depicts a power drive with eleven driver rollers 404 circumferentially surrounding ten lobes 614 of the multi-lobe cycloidal cam 612, which corresponds to a ten-to-one reduction. This relationship of rollers 404 and cam lobes 614 causes the output shaft portion 704 to rotate in the opposite direction as the rotation of the input shaft portion 204. It is anticipated that other combinations of rollers 404 and cam lobes 614 can be used to obtain other torque conversion ratios.

The conversion driver host 304 is captive to and orbited by the input 200. The conversion driver host 304 is encompassed by the input cam 216. The driver hose 304 is coupled to the conversion bias generator host 502. The conversion driver host 304 is static in operation in this example. The translator 600 includes a hypocardioid cam 612 that includes seven lobes, e.g., hypocardioids, which are coupled to the output shaft 700, the rotational center 702 of which is the center of this embodiment.

A plurality of rollers 410 are radially disposed around the translator 600 such that a point offset drawn to the center of any roller 404 will be equidistant to the center or the remaining rollers. Each roller 404 is disposed in a piston 374 which is positioned within a piston slot 392 of the driving host 304. The piston 374 conveys a force through the orbiter ring 358 to the rollers 404. The ring 358 is positioned between the piston ring 358, the exterior surface 362 and the eccentric, interior axial surface 218 of the input cam 206.

When the embodiments are in zero position, or 0 degrees position, the input cam perpendicular face 210 is in line along the horizontal rotation center 402 of the roller 406 and its piston 374. The roller 406 is tangent to the primary translator lobe 616 and the translator rotational center 602.

As the input cam 206, rotates (clockwise is assumed) the 0° position 210, advances toward the 180° position 242, at the host 304, and likewise the 180° position 212, of the input cam 206, advances toward the 0° position 210, of the conversion driver host 304. As this rotation occurs, a broadening portion of the cam face 208, passes by the position 210 of the host 304. This displaces the driver piston ring 358 and causes it to orbit in a clockwise direction. When the driver piston orbiter ring 358 orbits, it acts to displace the driver pistons 374 and the rollers 404 causing the translator 600 to rotate to a counter clockwise rotation. There is a crescent shaped free space 372 between the host 304, the exterior concentric axial wall 314, the orbiter ring 358 and the interior axial surface 364. As the orbiter ring 358 orbits around the host 304, so does the free space.

Two forms of motion occur in the ring 358: 1) on orbit for each rotation of the cam 206, and rotation, at the rate of a speed reduction, of the translator 600. One rotation of the cam 206 will cause the translator 600 to move the distance of the width of one cam lobe 614.

Due to the static bias mod of this configuration, the conversion drive host 304 is immobile. When an attempt is made to back drive the output shaft 704, the translator will attempt to drive the rollers 410. However, as 0 and 180 are the only points at which the rollers 410 are at an angle, normal to the translator 600, translator love 614, being in contact with a roller 404, other than at a normal angle, which the translator lobe crest, or 0 degrees position, is advancing or rotating toward the driver roller center of rotation 402, will exert pressure on the driver roller 404, at an oblique angle, which oblique pressure will proceed through the roller 404 and the piston 374 to which it is captive, driving the piston wall deflector wall 376 against the piston slot guide wall 394 of the static mode driver host 384. The oblique force, being partially absorbed by the piston slot guide wall 394 and driving the piston ring contact surface 382 into contact against the driving piston orbiter ring, interior axial surface 364. As the driver piston 374 is normal to and inside the ring 358, it is not able to induce rotation of the ring 358 and the input cam.

FIG. 1 relates to a second embodiment of a transmission. The torque conversion assembly of the second embodiment includes a front roller keep 342 located nearest the output end 120 of the main housing 102 and a rear roller keep 330 located nearest the input end 104. The rear roller keep 330 has a concentric aperture 352 sized and located to permit the input shaft extension 224 to be received by the cavity 706 in the output shaft portion 704, and thus stabilize the output structure 700 by providing it with a means of support and rigidity. The front roller keep 342 has a concentric aperture 704 sized and located to permit the output shaft portion 704 to extend through the front roller keep 342. A plurality of rollers 410 is seated within a plurality of driver apertures 340 in the rear roller keep 330 and a plurality of driver apertures 354, 356 in the front roller keep 342, wherein the rollers 410 and the front 342 and rear 330 roller keeps form a cylindrical structure. The conversion driver host 304 is formed by the front 342 and rear 330 roller keeps.

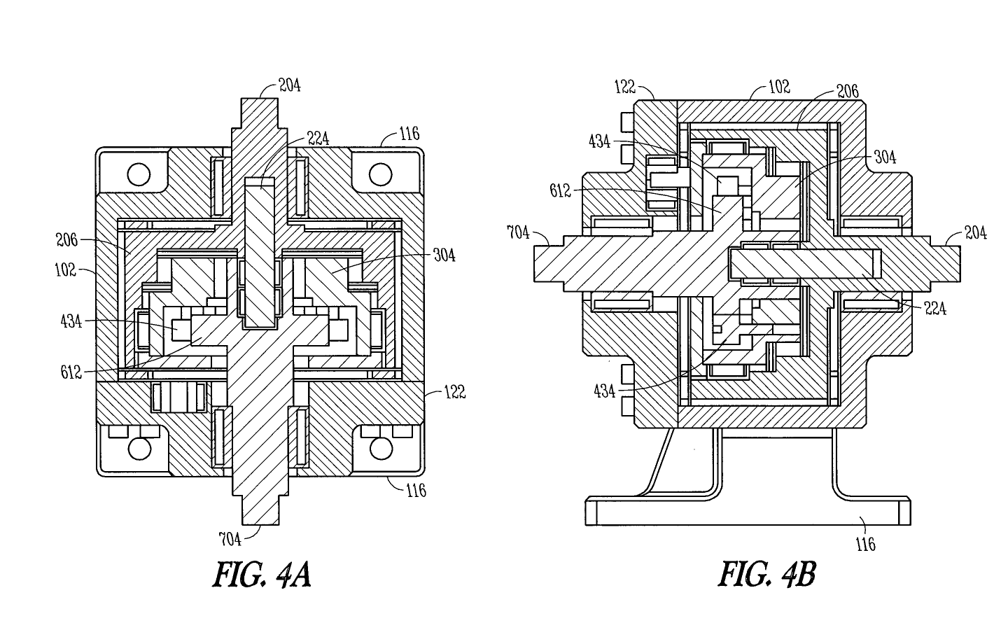

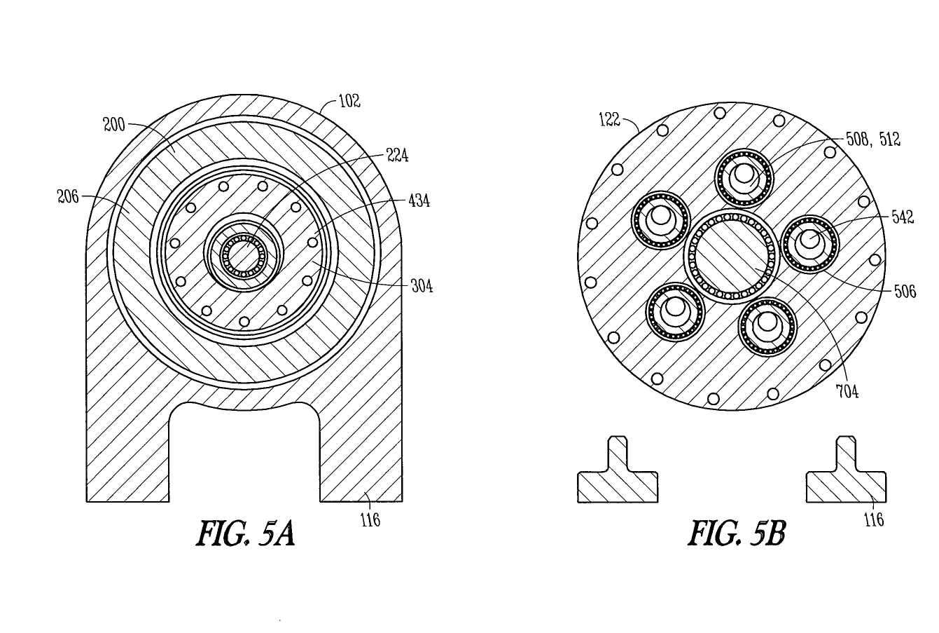

The plurality of rollers 410 form the conversion driver 400 of the torque conversion assembly 300. As shown in FIGS. 4 and 5, the rollers in this embodiment include of a plurality of long driver rollers consisting of a driver segment 432 and a bias relay extension 534 interposed within a plurality of short driver rollers 428.

The multi-mode bias 500 includes an orbital bias generator 504 found within the bias generator host 502, and includes a bias relay assembly 530. The bias relay assembly 530 further includes the front roller keep 342 that serves as a bias relay host 536 and the bias relay extensions 534. The bias generator host 502 is fixedly attached to the front cover 122 of the housing structure 100.

The bias relay extensions 534 extend through the front roller keep through apertures 354 of the front roller keep 342 and interact with the orbital bias generator 504. The orbital bias generator 504 includes a plurality of bias generator cams 508 and sleeve bearings 546. The bias generator cams 508 in this embodiment are sized to receive both the bias relay extensions 534 and the corresponding sleeve bearings 546 in such a manner as to give the bias relay extensions 534 an orbital motion. Thus, the orbital bias generator 504 and bias relay assembly 530 cooperate with the eccentric interior cam portion 216 of the input cam portion 206 to produce the orbital motion of the conversion driver host 304 in the torque conversion assembly 300.

The torque conversion translator 600 of the torque conversion assembly 300 is formed by a multi-lobe cycloidal cam 612 integrally formed about the circumference of the output shaft portion 704. The driver rollers 428, 430 are in operational contact with the multi-lobe cycloidal cam 602 of the torque conversion translator 600. FIG. 4 depicts a power drive with eight rollers 428, 430 circumferentially surrounding seven lobes 614 of the multi-lobe cycloidal cam 602, which corresponds to a seven-to-one reduction. This relationship of rollers 428, 430 and cam lobes 614 causes the output shaft portion 704 to rotate in the opposite direction as the rotation of the input shaft portion 204. It is anticipated that other combinations of rollers 428, 430 and lobes 614 can be used to obtain other torque conversion ratios.

When a back-rotational force is applied to the output shaft portion 704 in the second embodiment, a radially outward force is applied by the multi-lobe cycloidal cam 612 to the driver rollers 428, 430. As a result of this back rotational force, the conversion driver 400 will cause the conversion driver host 304 to apply a radially outward force against the eccentric interior cam portion 216. The configuration of the eccentric interior cam portion 216 prevents this radially outward force from creating a tangential resultant force that would produce rotational motion in the input structure 200. Thus, the second embodiment of the power transmitter possesses back drive resistant capabilities.

Since the conversion driver host 304 and driver rollers 428, 430 cannot orbit when the eccentric interior cam portion 216 of the input structure 200 does not rotate, the driver rollers 428, 430 lock with the cycloidal cam lobes 614 so that the output shaft portion 704 rotates only when the driver rollers 428, 430 and conversion driver host 304 rotate. However, the interaction of the bias relay extensions 534 with the orbital bias generator 504 in the bias generator host 502 prevents the rotational motion of the conversion driver host 304 with respect to the housing structure 100, and thus prevents the rotation of the output structure 700 without a controlling rotation of the input structure 200 that would allow the conversion driver host 304 to orbit. Therefore, the second embodiment of the power transmitter possess self-governing and self-braking capabilities.

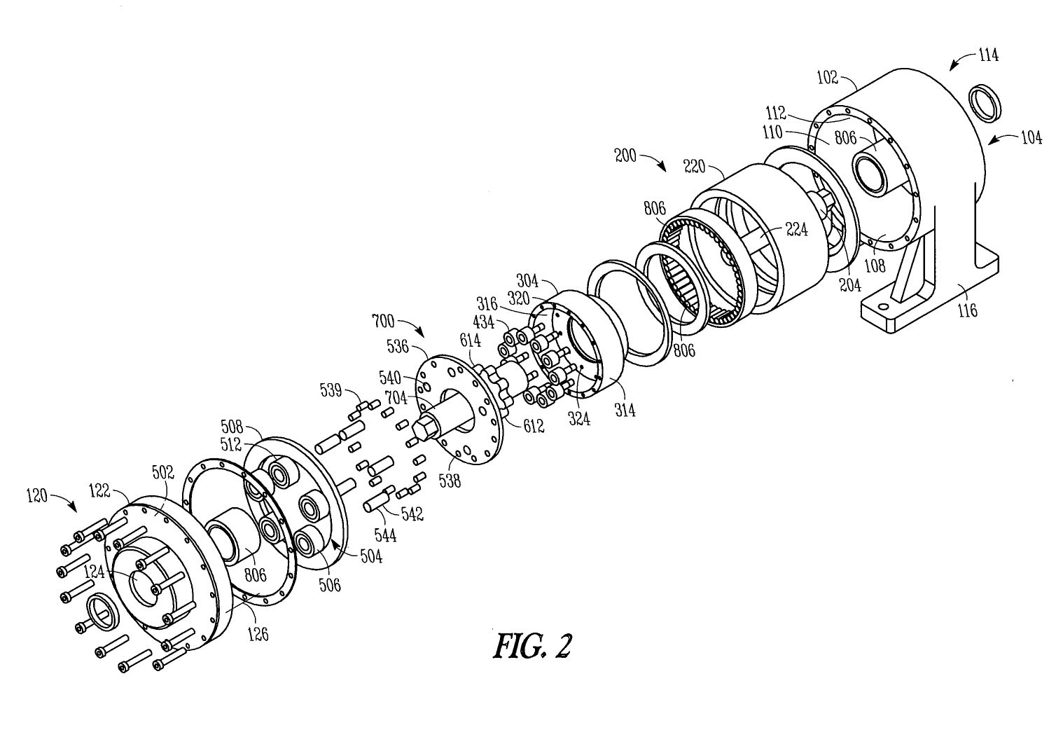

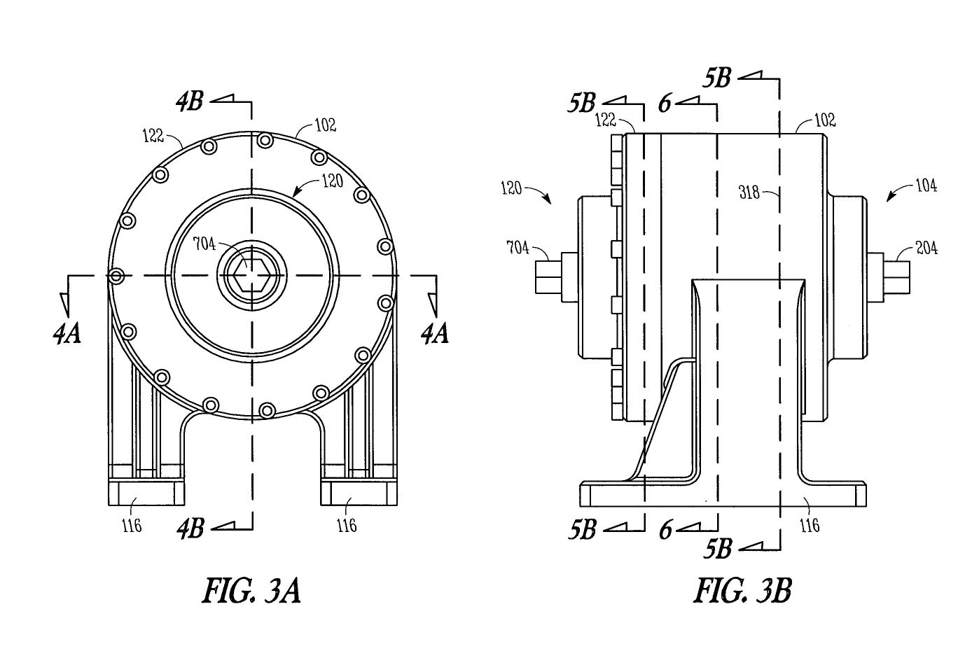

FIGS. 2-3, 4A-B, 5A-B, 6 and 12A-C relate to a third embodiment of a transmission. In the third embodiment, the torque conversion assembly 300 includes a discrete conversion driver host 304. The conversion driver host 304 contains a plurality of roller stud apertures 324 that circumferentially surrounds a concentric driver host aperture 318. The concentric driver host aperture 318 is sized and located to permit the input shaft extension 224 to be received by a cavity 706 in the output shaft portion 704, and thus stabilize the output structure 700 by providing it with a means of support and rigidity. A plurality of rollers 410 are seated in the plurality of roller stud apertures 324 and form the conversion driver 400 of the torque conversion assembly 300.

The multi-mode bias 500 includes an orbital bias generator 504 formed within a bias generator host 502 and a bias relay assembly 530. The bias relay host 536 of the bias relay assembly 530 takes the form of a plate that is fixedly attached to the conversion driver host 304. The bias relay host 304 has a concentric aperture 537 sized and located to receive the output shaft portion 704 through the bias relay host 304. The outside surface of the bias relay host 304 has a plurality of host relay pin apertures 540 in which a plurality of bias relay pins 542 are seated. The bias relay pins 542 interact with the orbital bias generator 504 formed in or fixedly attached to the bias generator host 502. The bias cams of the orbital bias generator 508 are sized to receive both the bias relay pins 542 and corresponding sleeve bearings 546 in such a manner as to give the bias relay pins 542 an orbital motion. Thus, the orbital bias generator 508 and the bias relay assembly 530 cooperate with the eccentric interior cam portion to produce the orbital motion of the conversion driver host 304 in the torque conversion assembly 300. The sleeve bearings 546 promote a smooth and efficient orbital motion.

The conversion translator 600 is formed by a multi-lobe cycloidal cam 612 integrally formed about the circumference of the output shaft portion 704. FIG. 6 depicts a power drive with eleven stud-type needle bearing rollers 434 circumferentially surrounding ten lobes 614 of the multi-lobe cycloidal cam 612, which corresponds to a ten-to-one reduction. This relationship of rollers 434 and cam lobes 614 causes the output shaft portion 704 to rotate in the opposite direction of the rotation of the input shaft portion 204. It is anticipated that other combinations of rollers 434 and cam lobes 614 can be used to obtain other torque conversion ratios.

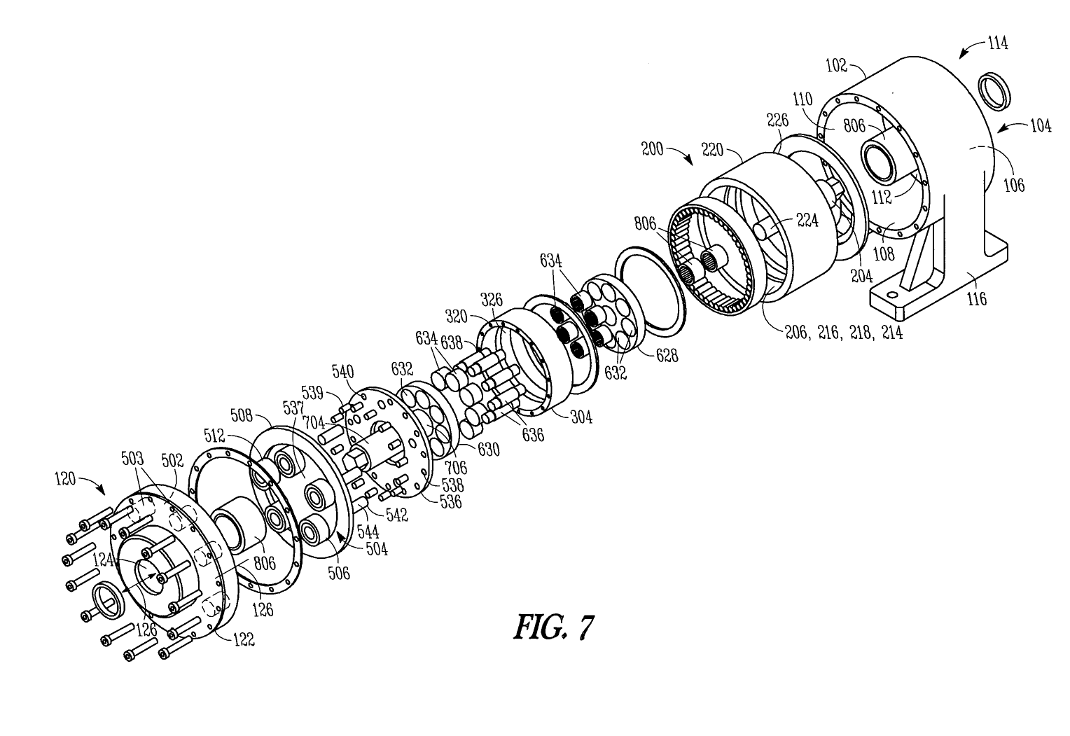

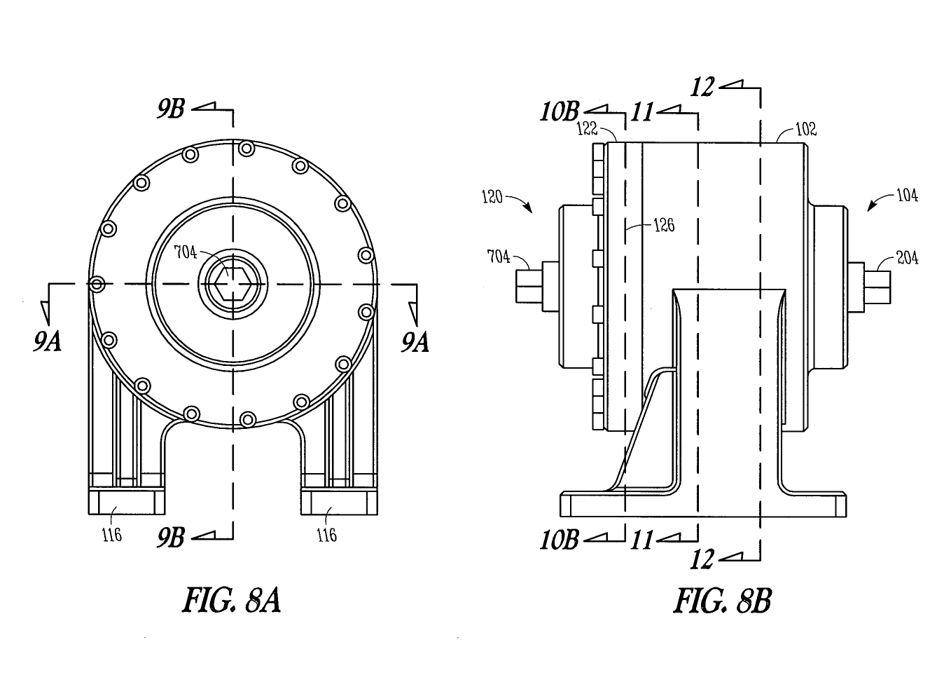

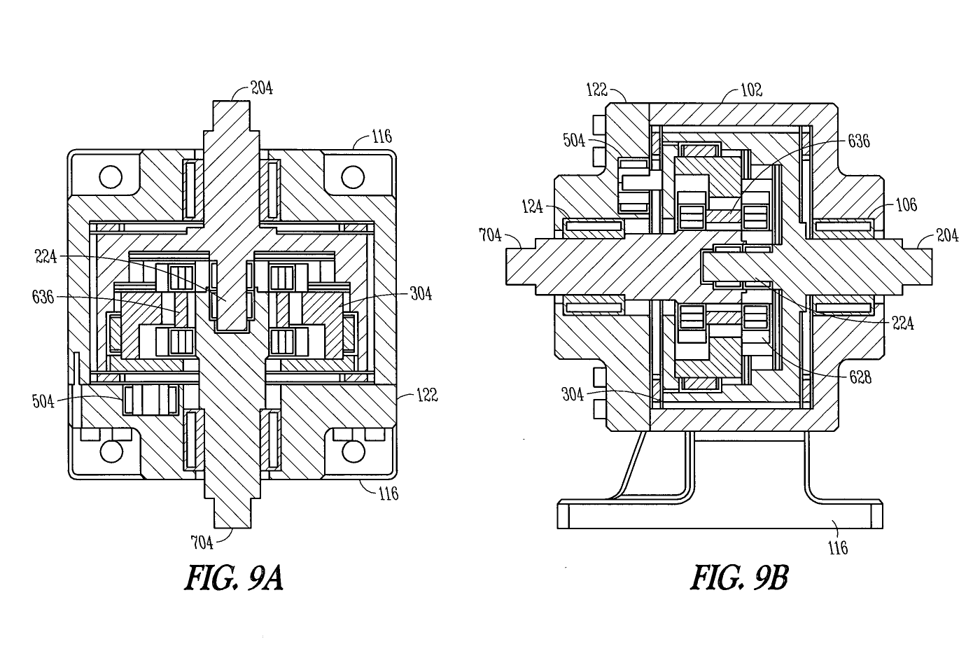

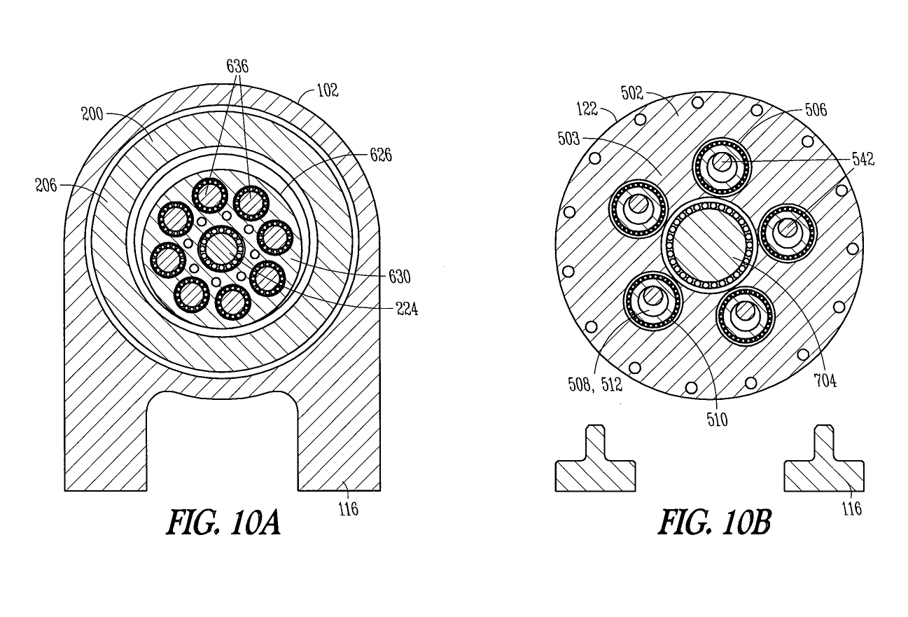

FIGS. 7, 8A-B, 9A-B, 10A-B, 11 and 13A-B relate to a fourth embodiment of a transmission. In the fourth embodiment, the torque conversion assembly 300 includes a conversion driver host 304 having a driver form of an inverted multi-cardioid cam 412. The inverted multi-cardioid cam 412 forms the torque conversion driver 400.

The multi-mode bias 500 includes an orbital bias generator 504 formed within a bias generator host 502 and a bias relay assembly 530. The bias relay host 536 of the bias relay assembly 530 takes the form of a plate that is fixedly attached to the conversion driver host 304. The bias relay host 536 has a concentric aperture 537 sized and located to receive the output shaft portion 704 through the bias relay host 536. The outside surface of the bias relay host 536 has a plurality of host relay pin apertures 540 in which a plurality of bias relay pins 542 are seated. The bias relay pins 542 interact with the orbital bias generator 508 formed in or fixedly attached to the bias generator host 502. The bias cams of the orbital bias generator 508 are sized to receive both the bias relay pins 542 and corresponding sleeve bearings 546 in such a manner as to give the bias relay pins 542 an orbital motion. Thus, the orbital bias generator 508 and the bias relay assembly 530 cooperate with the eccentric interior cam portion 216 to produce the orbital motion of the conversion driver host 304 in the torque conversion assembly 300. The sleeve bearings 546 promote a smooth and efficient orbital motion.

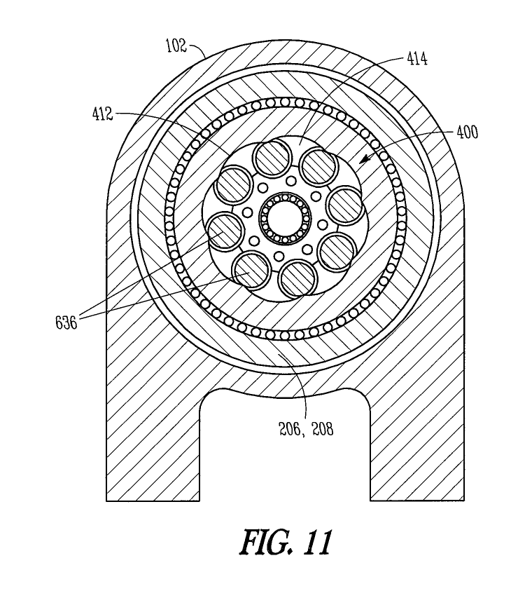

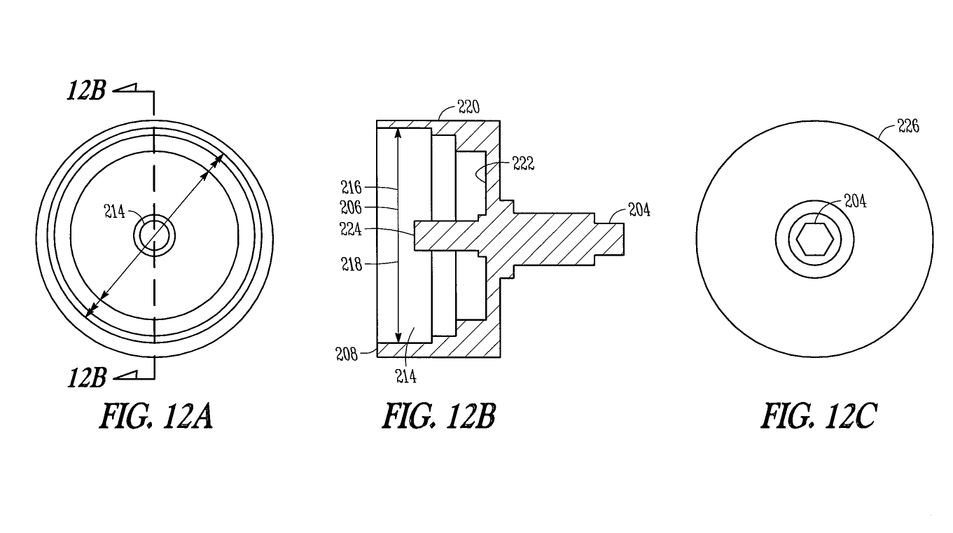

The translator 600 of the torque conversion assembly 300 includes an annular rear bearing keep 628, a plurality of translator rollers 636, and an annular front bearing keep 630 integrally formed with the output shaft portion 704. Both the rear bearing keep 628 and the front bearing keep 630 have a plurality of roller bearing apertures 632 sized and located to receive the plurality of translator rollers 636, wherein the rear bearing keep 628, the translator rollers 636, and the front bearing keep 630 form a cylindrical structure that form the translator 600 of the torque conversion assembly 300. FIG. 11 depicts a power drive with seven inverted cardioid scallops 416 circumferentially surrounding eight translator rollers 636, which corresponds to an eight-to-one reduction. This relationship of translator rollers 636 and inverted cardioid scallops 416 causes the output shaft portion 704 to rotate in the same direction as the rotation of the input shaft portion 204. It is anticipated that other combinations of scallops 416 and translator rollers 636 can be used to obtain other torque conversion ratios.

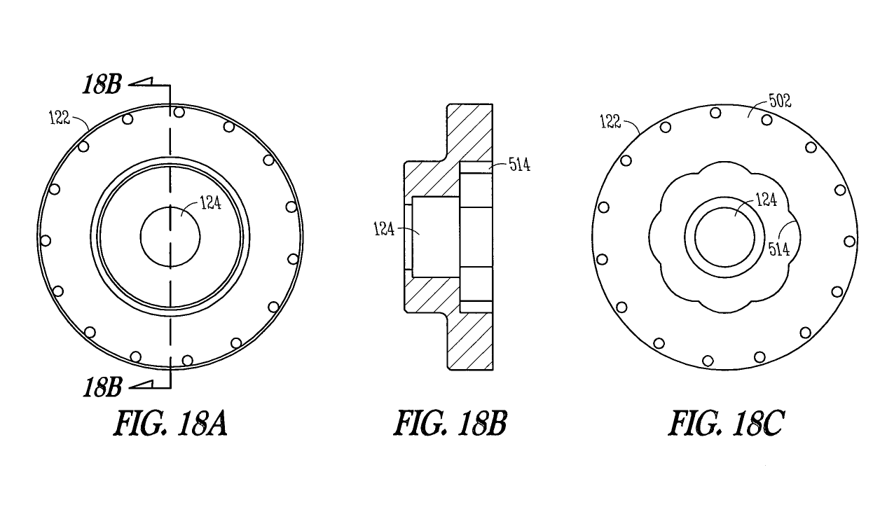

FIGS. 18A-C relate to a fifth embodiment of a transmission. In the fifth embodiment, the torque conversion assembly 300 includes a discrete conversion driver host 304. The conversion driver host 304 contains a plurality of roller stud apertures 324 that circumferentially surrounds a concentric driver host aperture 318. The concentric driver host aperture 318 is sized and located to permit the input shaft extension 224 to be received by a cavity 706 in the output shaft portion 704, and thus stabilize the output structure 700 by providing it with a means of support and rigidity. A plurality of rollers 410 are seated in the plurality of roller stud apertures 324 and form the conversion driver 400 of the torque conversion assembly 300.

The multi-mode bias 500 includes a cycloidal pulsed orbit generator 518 formed within a bias generator host 502 and includes a bias relay assembly 530. The cycloidal pulsed orbital generator 518 takes the form of an inverted multi-cardioid cam 604 shown in FIGS. 18A-C. The bias relay host 536 of the bias relay assembly 530 takes the form of a plate that is fixedly attached to the conversion driver host 536. The bias relay host 536 has a concentric aperture 537 sized and located to receive the output shaft portion 704 through the bias relay host 536. The outside surface of the bias relay host 536 has a plurality of host relay pin apertures 540 in which a plurality of stud type needle roller bearings 804 are seated. The stud type needle roller bearings 804 interact with the cycloidal pulsed orbital bias generator 518 formed in or fixedly attached to the bias generator host 502. The bias cams of the cycloidal pulsed orbital bias generator 518 are the stud type needle roller bearings 804 in such a manner as to give the stud type needle roller bearings 804 a cycloidal pulsed orbital motion. Thus, the cycloidal pulsed orbital bias generator 518 and the bias relay assembly 530 cooperate with the eccentric interior cam portion 216 to produce the cycloidal pulsed orbital motion of the conversion driver host 304 in the torque conversion assembly 300.

The conversion translator 600 is formed by a multi-lobe cycloidal cam 612 integrally formed about the circumference of the output shaft portion 704. FIG. 6 depicts a power drive with eleven stud type needle bearing rollers 434 circumferentially surrounding ten lobes 614 of the multi-lobe cycloidal cam 612, which corresponds to a ten-to-one reduction. This relationship of rollers 434 and cam lobes 614 causes the output shaft portion 704 to rotate in the opposite direction as the rotation of the input shaft portion 204. It is anticipated that other combinations of rollers 434 and cam lobes 614 can be used to obtain other torque conversion ratios to obtain other torque conversion ratios.

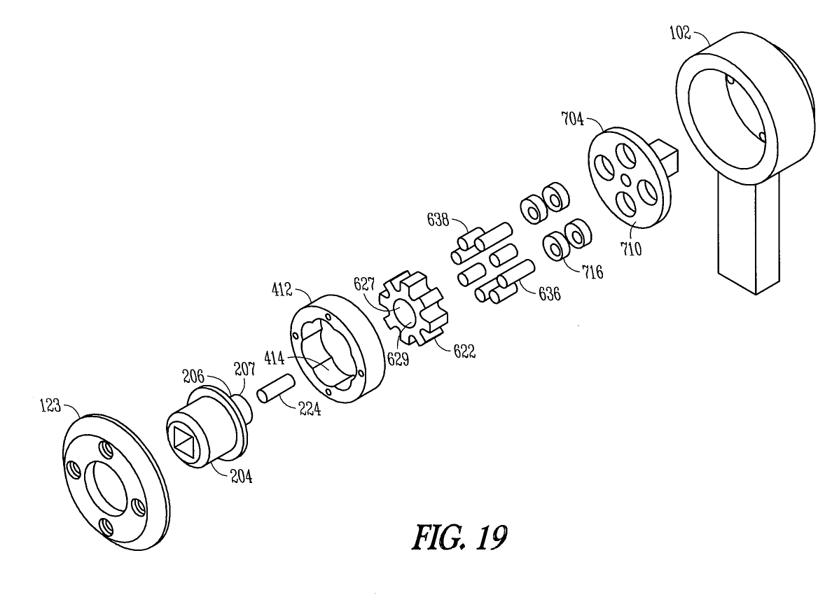

FIG. 19 relates to a sixth embodiment of a transmission. In the embodiment, the conversion driver 400 of the sixth embodiment takes the form of an inverted multi-cardioid cam 412. Since the driver 400 is fixedly attached to the main body of housing 102, it is immobile with respect to the housing structure 100. The conversion translator 600 includes a translator host and relay assembly 622 and translator rollers 636.

Although the working relationship of the driver 400 to the translator 600 is similar to the fourth embodiment, an important difference in this sixth embodiment is that the translator 600, rather than the driver 400, is orbited by the input cam 216.

The eccentric exterior axial wall 204 center drives the conversion translator 600. The rotation of the input shaft 204 causes the translator host 622 to orbit about the input rotational axis 202. One complete 360° rotation of the input cam 216 causes one complete 360° orbit of the translator host 622 and advances the translator rollers 636 one position. Eight complete 360° rotations of the input cam 216 causes ten complete 360° orbits of the translator host 622 and rotates the translator 600 and the output structure 700 one complete 360°. Reduction in this embodiment is eight to one since eight rotations of the input structure 200 causes eight orbits of the translator 600, which causes one complete rotation of the output shaft portion 704.

The sixth embodiment is a compact design because the eccentric cam portion 216 only needs to orbit the translator 600. Therefore, multiple stages could easily be configured to produce a high reduction ratio within an efficiently sized housing.

FIGS. 20-23 relate to a seventh embodiment of a transmission. The seventh embodiment uses a planar input structure 201, planar driver 436, and planar translator 640 to induce a new degree of orbital motion. Specifically, the planar design causes a portion of the input force to be transmitted longitudinally along the input and output axes of the drive. This allows the drive to accept an input force that is not purely rotational.

The planar driver 436 may take the same form as any of the other embodiments, i.e. it may take the form of either a planar inverted cardioid cam form 809 or a multi-lobe cycloidal cam form 817 and the planar translator 640 may take the form of a multi-lobe cycloidal cam form 817 or a planar inverted cardioid cam form 809. Planar taper rollers 438, 642 are used to transmit power between the driver 400 and translator 600.

Embodiments 1-5 also show the eccentric interior cam portion 216 circumferentially containing the conversion driver host 304 of the torque conversion assembly 300. However, the power transmitter can be easily configured in a way in which the linear dimension of the device is increased and the diametric dimension is decreased by, for example, using a diametrically smaller eccentric interior cam portion 216 in conjunction with a diametrically small shaft that forms an integral part of the conversion driver host 304. The eccentric interior cam portion 216 would only circumferentially surround the smaller shaft integral to the conversion driver host 304 rather than the entire driver host 304. However, the eccentric member would still drive the output member radially inward into the center of the device. The seventh embodiment is an example of a smaller eccentric interior cam portion that can be used to decrease the diametrical dimension of the power transmitter 10.

The embodiments are configured as cam-only devices, wherein the conversion driver 400 and conversion translator 600 have a cycloidal relationship exemplified in FIG. 15. These reaction surfaces may be combinations of rollers, ball bearings, multi-lobe cams, and multi scallop cycloidal surfaces. In addition, any form of gearing found in the prior art planetary drive systems can be used. The types of forms used as a driver or translator also can be used as a bias. These form types can be interchanged among the driver, bias and translator. Therefore, the bias can take numerous forms including geared forms.

It is anticipated that multiple stages can be added in a cascading fashion to the input structure 200, the output structure 700, or the torque conversion assembly 300. As mentioned previously, the embodiments show the multi-mode bias 500 of the torque conversion assembly 300 coupled with the housing structure 100. However, the bias generator host 502 of the multi-mode bias 500 could be embodied within a rotatable plate that could drive a concentric output load. Therefore, for example, both the torque conversion assembly 300 and the output structure 700 could be used within a differential drive system or to provide further torque reduction. In addition, it is anticipated that this configurability would allow the present subject matter to be configured to have multiple inputs as well as multiple outputs.

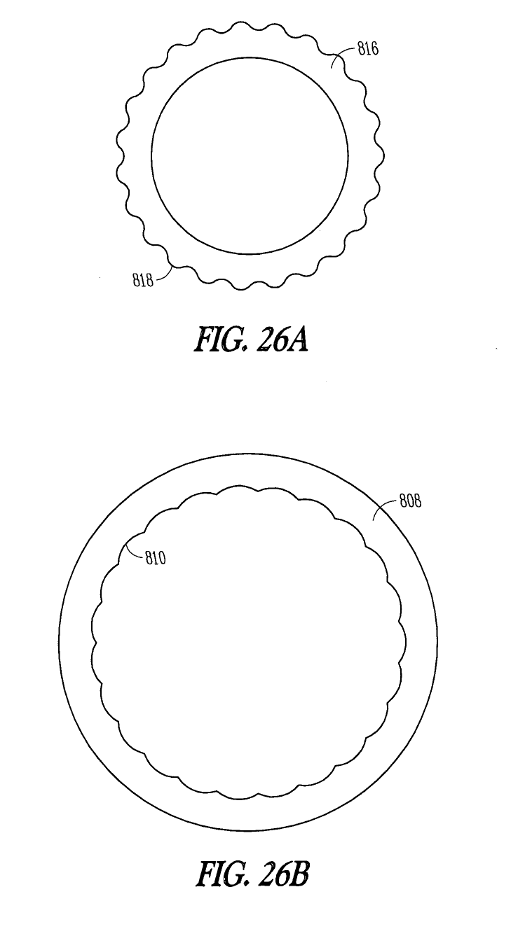

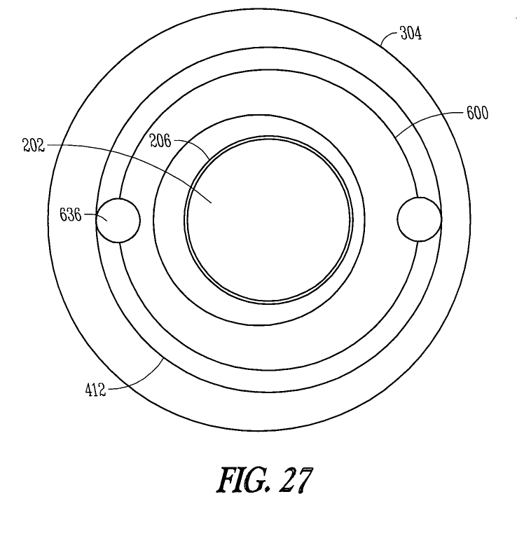

FIG. 24 is a front view of an inverted camshaft carrier, according to some embodiments. These embodiments provide an alternative camshaft-pinion interface. Instead of the pinion having a cammed surface as set out above, the carrier has a cammed surface. For example, the carrier 1102 includes an inverted multi-cardioid cam surface 1104.

The pinion 622 is disposed in the carrier 1102. In various embodiments, rollers 636 are disposed in the pinion 622. In additional embodiments, lobes are formed into the pinion 622 so the pinion and its lobes are part of the same monolith.

The pinion 622 can be fixedly coupled to an output shaft or it can be fixedly coupled to a housing. In some examples, a carrier includes an inverted camshaft for both a pinion coupled to a housing and for an output pinion.

In various embodiments, an eccentric exterior axial wall of an input drives the carrier 1102. The rotation of the input shaft 204 causes the carrier 1102 to orbit about the input rotational axis 1112. In an example, one complete 360 rotation of an input causes one complete 360 degree orbit of the carrier 1102 and advances the translator rollers 636 from one inversion to a neighboring inversion. In various embodiments, eight complete 360 rotations of an input causes ten complete 360 orbits of the carrier 1102 and rotates an output 627 360 degrees. Reduction in such embodiments is eight to one since eight rotations of an input causes eight orbits of a carrier, which causes one complete rotation of an output shaft.

Transmissions as set out above are used in several ways. For example, in some embodiments, a transmission is used for transmitting rotational force that is applied to the input while braking the rotational force when it is applied to the output. One or more of the transmission embodiments described herein can be used to insulate a worker who is turning a bolt from the danger of the bolt twisting opposite the input from the worker. For example, if a worker were torquing a bolt clockwise, and the bolt suddenly started to provide a large torque counterclockwise (e.g., to release energy inputted by the worker), the present subject matter would protect the worker from the backlash by resisting backdriving of the transmission input due to the bolt's torque on the transmission output. In various embodiments, the transmission is fixed to a stable structure when it is in use, so that the transmission housing doesn't spin.

FIGS. 14 and 28 relate to an eighth embodiment of the present subject matter. The embodiment includes a housing plate 2402, a input 2404, a cam follower 2404, and inner ring 2408, and output 2410, an outer ring 2412 and a further housing plate 2414. As the input 2404 is spun, the cam follower 2404 imparts a force onto the inner ring 2408, which is caused to rotate in synchronization with the outer ring 2412. This rotation imparts a force from the inner ring 2408 onto the pins 2415, which causes the output 2410 to rotate.

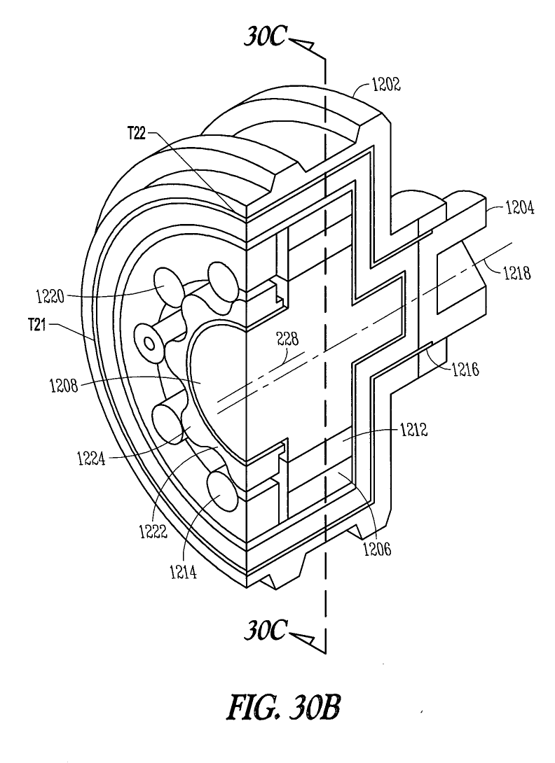

FIG. 29 is a diagram of a transmission assembly 1100 viewed from the side, according to various embodiments. Three transmissions 1102, 1112 and 1114 are illustrated. Transmission 1112 is cross sectioned through the input 1132 and the output 1116. Transmission 1102 includes an output 1110 that is coupled to the input 1138 of transmission 1112. The output 1124 of transmission 1112 is coupled to the input 1116 of transmission 1114.

The center transmission 1112 includes a housing 1126. To simplify explanation, this housing 1126 and some other components are represented by lines. In practice, these lines have a thickness. Surfaces that are phased with one another are illustrated with parallel lines of equal length. Phased surfaces are those that do not slip with respect to one another. Bearings are illustrated as rectangles with an “X” through them.

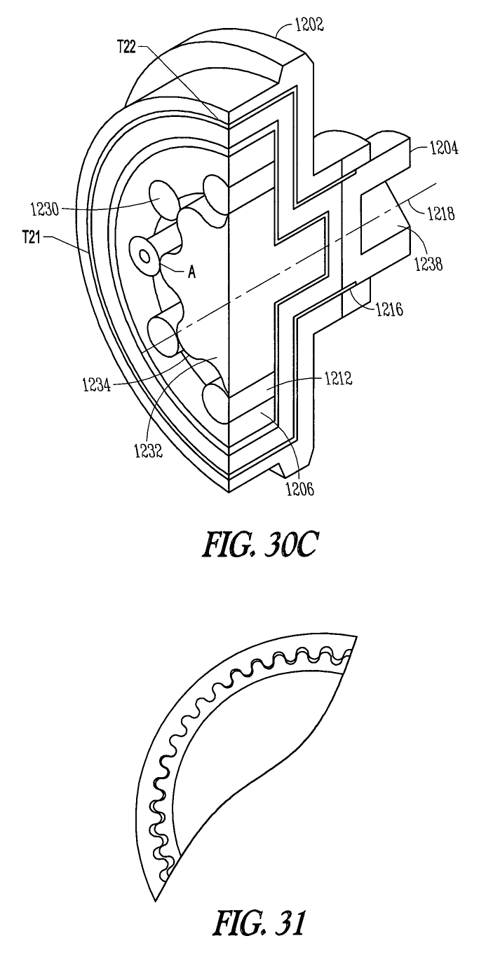

In some embodiments the transmission 1112 is backdrive resistant. Backdrive resistant transmissions restrict rotation of the output 1124 when a backdrive torque is applied to the output 1124. One embodiment of a backdrive resistant transmission is represented in FIGS. 30-38. Those illustrations are not schematic and show actual parts and can be used for reference to understand how at least one embodiment of the machines represented by FIG. 29 function. The transmission 1112 also governs the speed at which an output will turn when a torque is applied to the input.

A brief description of how the transmission 1112 functions is provided here to provide an overview that is not intended to be limiting. The input 1132 of transmission 1112 and output rotate around centerline 1130. As a torque is imparted onto input 1132, a portion of the input including an offset bore 1128 (having centerline 1136) rotates in the housing 1126. As it rotates, the input imparts motion onto a carrier 1144. The carrier 1144 is forced to rotate in phase with the housing 1126 due to interaction over a phased interface 1148 via a housing pinion 1146 that is coupled to the housing 1126. As the carrier 1144 rotates, it imparts rotation to an output 1124 via a phased interface 1152. The output 1124 extends through the housing 1126 and spins in relation to the housing 1126.

Returning to a discussion of the assembly 1100, first transmission 1102 includes an input 1104. The transmission 1102 also includes a transmission body 1105. The transmission body 1106 houses a torque transmitter 1108. The torque transmitter 1108 is coupled to the input 1104 to transmit a torque applied to the input 1104. An output 1110 is coupled to the torque transmitter 1108 to further transmit the torque to another device that uses torque, such as transmission 1112.

The first transmission 1102 can be any sort of transmission including, but not limited to, transmissions that have an input and an output that rotate at a 1:1 ratio, as well as those that do not rotate at a 1:1 ratio. The torque transmitter 1108 can include one or more gear sets, brakes, clutches and the like. The transmission 1102 can optionally be shifted to a neutral mode where the input and output are free to spin independent of one another.

A second transmission 1114 can optionally be included. The transmission 1114 includes an input 1116. The transmission 1102 also includes a transmission body 1118. The transmission body 1118 houses a torque transmitter 1120. The torque transmitter 1120 is coupled to the input 1116 to transmit a torque applied to the input 1116. An output 1122 is coupled to the torque transmitter 1120 to further transmit the torque to another device that uses torque, such as transmission 1112.

The second transmission 1114 can be any sort of transmission including, but not limited to, transmissions that have an input and an output that rotate at a 1:1 ratio, as well as those that do not rotate at a 1:1 ratio. The torque transmitter 1120 can include one or more gear sets, brakes, clutches and the like. The transmission 1114 can also optionally be shifted to a neutral mode.

The first 1102 and second 1114 transmissions are optional portions of the transmission assembly 1100. These transmissions can be any of a number of devices, such as power tools and other industrial machines, winches, vehicular components to propel vehicles, and other components. By adding a backdrive resistant transmission to one of these devices, these devices become backdrive resistant, adding further function.

The transmission 1112 includes housing 1126. The housing 1126 has a housing bore 1128. This housing bore 1128 has a housing bore centerline 1130. The input 1132 is rotably disposed in the bore 1128. In various embodiments, the input 1132 is coupled to the output 1110 of the first transmission. In further embodiments, the input 1132 is coupled to another device, such as a motor or an engine.

The input has an input bore 1134 that is eccentric and offset from the housing bore. The input bore 1134 has an input bore centerline 1136 that is parallel the housing bore centerline 1130. Because these two centerlines are not coincident, the input bore 1134 oscillates from the point of view of the housing 1126 as the input 1132 is spun. This oscillatory or orbital motion induces both rotary force to a pinion and lateral force to a pinion, as set out herein.

The input also includes an input interface 1138 to couple to a coupling. Examples of possible configurations for input interface 1138 include a female socket (e.g., that which is commonly used for hand tools), a threaded shaft, a shaft with an eye for a pin or another interface. The shaft could include a key or one or more shear pins as disclosed herein. The input interface 1138 extends through the housing 1126.

The input is constrained inside the housing 1126 by bearings 1140 and 1142. These bearing constrain motion of the input 1132 perpendicular to the housing bore centerline 1130. Further bearing can be added to constrain motion along a direction parallel to the housing bore centerline 1130. The bearings can be of any sort, including hydrodynamic bearing, roller bearings, ball bearings, or bushings that can be optionally impregnated with a lubricant.

The transmission 1112 includes a carrier 1144 rotably disposed in the input bore 1134. Accordingly, as the input 1132 rotates, the carrier 1144 oscillates from the point of view of the housing 1126. In various embodiments, the carrier 1144 includes a first 1154 and second 1156 set of protrusions that are inwardly extending, each set located along a pitch circle (shown here bisected) that is substantially perpendicular to the housing bore centerline 1130.

A housing pinion 1146 is coupled to the housing. The housing pinion 1146 is disposed at least partially through the carrier 1144 and has housing pinion protrusions 1158 that engage the first set of protrusions 1154. This engagement provides for the phased interface 1148. The phased interface 1148 can include gears, cams, or another surface capable of phased engagement. A phased interface 1148 ensures that any rotation of the first protrusions 1154 results in movement of the housing pinion protrusions 1158 according to a specified ratio.

In various embodiments, the pitch circle of the first set of protrusions 1154 is larger than the pitch circle of the housing pinion protrusions 1158 such that the housing pinion 1146 moves along a hypocycloidal path with respect to the carrier 1144. Lateral motion of the housing pinion 1146 with respect to the carrier 1144 is facilitated by the oscillation of the carrier as discussed above. Lateral motion is any motion perpendicular to centerline 1130. Accordingly, a torque applied to the input 1132 forces the carrier 1144 against the housing pinion 1146. The carrier 1144 engages the housing pinion 1146 and the housing pinion is fixed and cannot rotate, so the housing pinion 1146 imparts a lateral force and a tangential force to the carrier 1144. This force causes the carrier 1144 to rotate inside the input bore 1134 and with respect to the input 1132. This rotation ultimately results in the rotation of the output 1124.

The output 1124 includes an output interface 1160 and an output pinion 1150 disposed at least partially in the carrier 1144. The output pinion includes output pinion protrusions 1162 that engage the second set of protrusions 1156 such that the output pinion protrusions 1162 are forced into motion as the carrier oscillates around the output 1124. In various embodiments, the pitch circle of the output pinion protrusions 1162 and the second set of protrusions 1156 of the carrier 1144 are sized such that the output pinion moves along a hypocycloidal path. The hypocycloidal path is facilitated in the lateral direction by the oscillation of the carrier 1144. The output 1124 spins inside of the housing 1126 and is constrained from lateral motion because of this.

In various embodiments, the pitch circles of the first phased interface 1148 and the second phased interface 1152 are different so that torque is multiplied between the input 1132 and the output 1124 due to mechanical advantage. For example, in some embodiments, the pitch circle of the first phased interface 1148 is larger than the pitch circle of the second phased interface 1152. This causes a mechanical advantage because the radial distance between the surface acted upon and the centerline through which the torque travels is larger for the larger pitch circle.

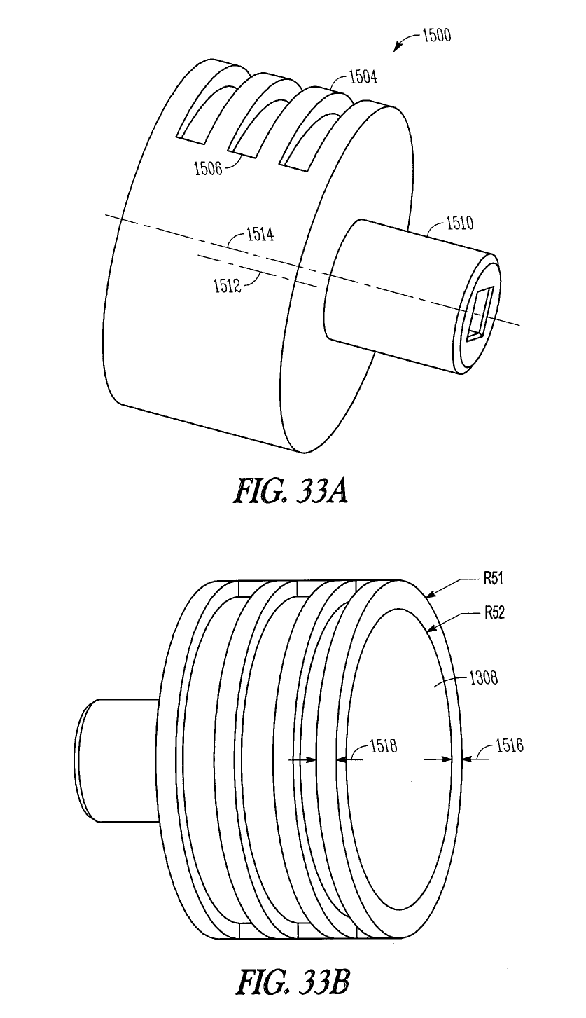

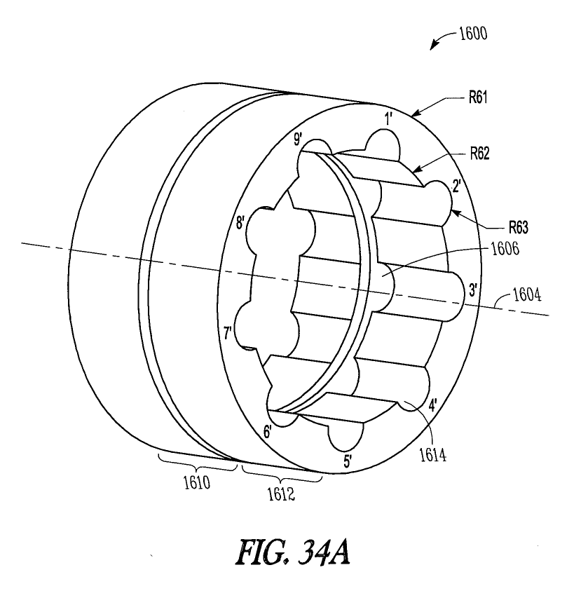

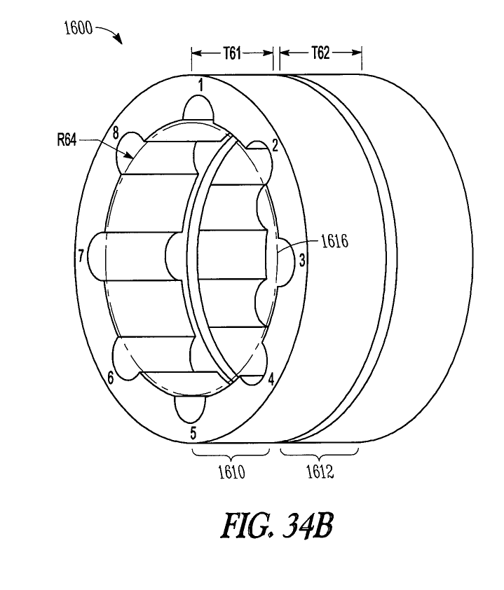

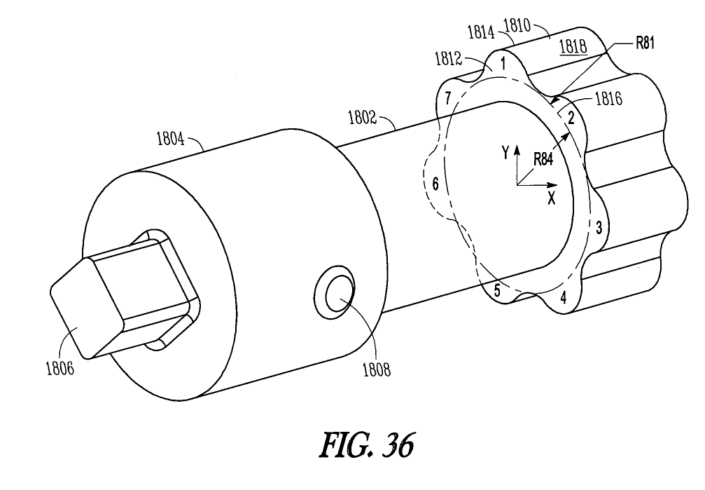

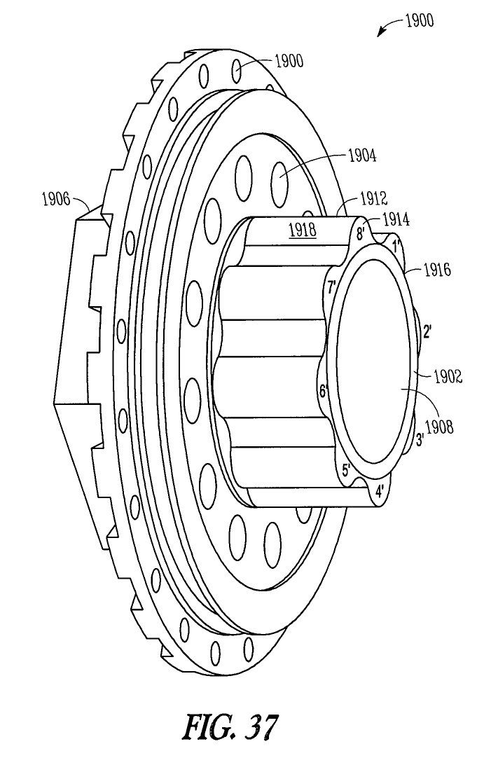

FIG. 30A is an isometric view of a cross section of a transmission, according to some embodiments. The backdrive resistant transmission 1200 includes a housing 1202 (illustrated in further detail in FIGS. 32 and 33), an input 1204 (illustrated in further detail in FIGS. 33A and 33B) rotably disposed in the housing 1202, a carrier 1206 (illustrated in further detail in FIGS. 34A and 34B) rotably disposed in the input 1204, and an output 1208 (illustrated in further detail in FIG. 36) rotably disposed in the housing 1202. A housing lid 1210 (illustrated in further detail in FIG. 37) is fixed to the housing 1202 to contain the carrier and portions of the input and output. The lid 1210 is shown with a plurality of fasteners coupling the lid 1210 to the housing 1202. Other fastening means are possible, including, but not limited to, threads and adhesives. In various embodiments, the carrier 1206, the housing pinion 1222 and output pinions 1232 are sealed into the housing by the housing lid 1210, with an output interface 1236 sealably extending through the housing lid 1210, and an input interface 1238 sealably extending through the housing 1202.

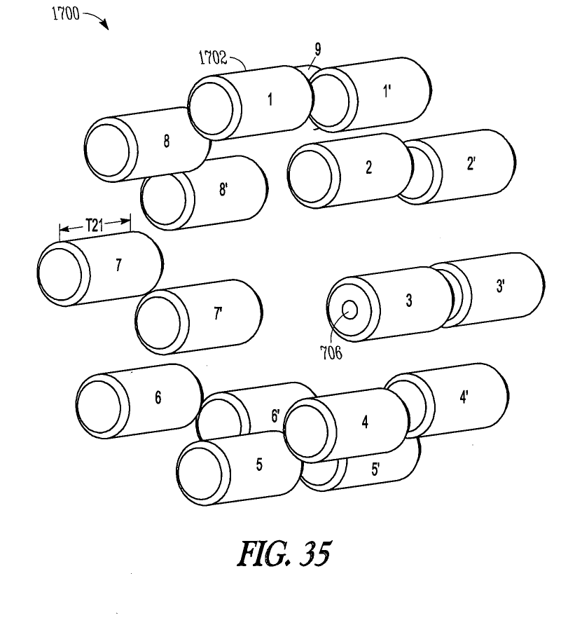

In various embodiments, protrusions from the carrier are defined by rollers 1212, 1214 (illustrated in further detail in FIG. 35). Although the element number 1212 points to a single roller, any of the rollers disposed around a first pitch circle are represented by the number 1212. Although the element number 1214 points to a single roller, any of the rollers disposed around a second pitch circle are represented by the number 1214. The rollers 1212 are part of a first set and are similarly shaped. The rollers 1214 are part of a second set and are similarly shaped. The rollers 1212 and 1214 are disposed in sockets that at least partially conform to a shape or form factor of the rollers 1212 1214. In some embodiments, the rollers 1212, 1214 are similarly sized. In additional embodiments, one set of rollers has a shape that is different from the other.

The rollers 1212, 1214 are cylindrical, having a length (the length of the center axis of the cylinder) and a width (the diameter of the cylinder). In some examples, the length is selected based on the backdrive torque that is applied to the output 1208. In some examples, the length is based on the torque applied to the input 1204. For example, a first application having a first torque requirement will have rollers of a first length, and a second application having a second torque requirement larger than the first torque requirement will have rollers of a second length that is longer than the first length.

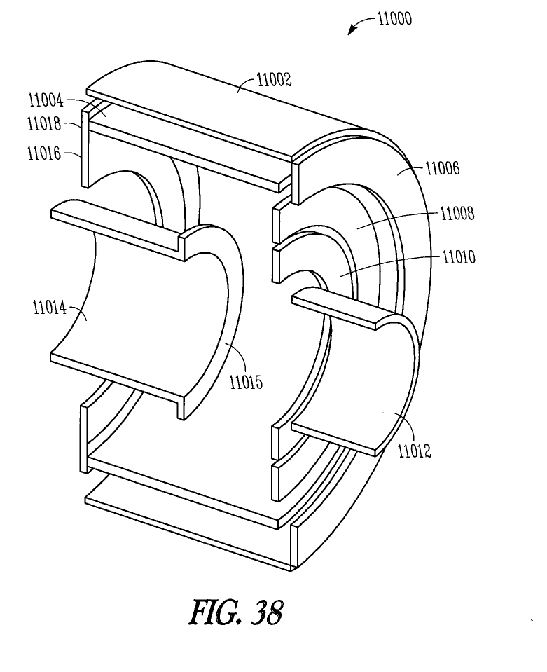

Several bearings are shown, with element number 1216 (illustrated in further detail in FIG. 38) pointing to one of the bearings. Each of these bearings can be of any bearing variety, including ball bearings, roller bearings and bushings. In the illustration, the bearings are shown with a common cross hatching pattern. Some of the bearings reduce friction caused by longitudinal forces that travel parallel to center line 1218, and some bearings reduce friction caused by forces lateral to center line 1218.

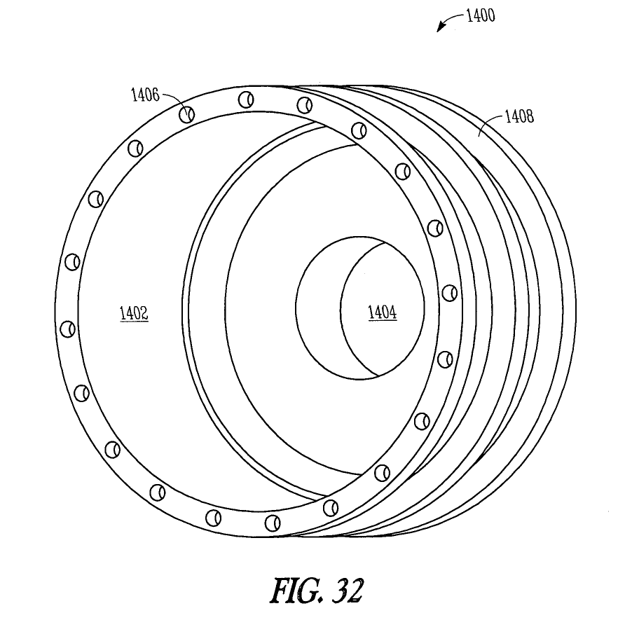

FIG. 30B is an isometric view taken along line 2B-2B in FIG. 30A. The illustration shows a first set of protrusions 1220. In the illustration, the first set of protrusions are defined by cam lobes, but the present subject matter can include further configurations to provide phased interaction, including, but not limited to, gears and friction providing surfaces such as rubber or rubberized rollers. A cam translates motion of a point rotating around an axis from circular to reciprocating or oscillating. FIG. 31 is a perspective view of a carrier and a pinion coupled at a geared interface, according to some embodiments. In various embodiments, carrier protrusions include gear teeth, and an interface with a pinion includes gear teeth to mesh with the gear teeth of the carrier. An example of a geared interface is illustrated in FIG. 31.

In FIG. 30B, the illustration shows a housing pinion 1222 that includes protrusions 1224. In the illustration the protrusions of the housing pinion 1222 are defined by cam lobes, but the present subject matter is not so limited. In various embodiments, the housing pinion protrusions 1224 are to mesh with the cam lobes of the first set of protrusions 1220. Meshing involves phased interaction during which point “A” follows a hypocycloidal path as the housing pinion rotates in the carrier 1206. A center axis 1228 of the housing pinion 1222 maintains parallel and rotates around the center line 1218. As the center axis 1228 rotates around the centerline 1218, it is equidistant to that centerline.

In some examples, the protrusions of the housing pinion, the pitch circle of the housing pinion, the protrusions of the carrier and the pitch circle of the first set of carrier protrusions are sized such that each of the protrusions of the housing pinion maintains a point of contact with a protrusion of first set of protrusions of the carrier. In some embodiments, this means that concurrently a first top land of the housing pinion is in contact with a first top land of the carrier while a second top land of the housing pinion is in contact with a bottom land of the carrier. Contact can include abutting, or near abutting. Use of the term “near” contemplates that the distance between the structures is within a specified distance or tolerance. Such a state requires an even number of protrusions, and the present subject matter is not limited to an event number of protrusions. For example, in some embodiments, the first set of protrusions includes 9 protrusions equidistant from one another. In various embodiments, the housing pinion includes 8 protrusions equidistant from one another to engage the first set of protrusions.

FIG. 30C is an isometric view taken along line 2C-2C in FIG. 30A. A second set of protrusions 1230 define cam lobes. An output pinion 1232 includes output pinion protrusions 1234 that define cam lobes. In some examples, the protrusions of the output pinion, the pitch circle of the output pinion, the protrusions of the carrier and the pitch circle of the carrier are sized such that each of the protrusions of the output pinion maintains a point of contact with a protrusion of the second set of protrusions of the carrier. In some embodiments, this means that concurrently a first top land of the output pinion is in contact with a first top land of the carrier while a second top land of the output pinion is in contact with a bottom land of the carrier. Contact can include abutting, or near abutting. In various embodiments, the output pinion protrusions 1234 mesh with the cam lobes of the second set of protrusions 1234. In various embodiments, the second set of protrusions are equidistant from one another includes 8 protrusions equidistant from one another. In various embodiments, the output pinion includes 7 protrusions equidistant from one another to engage the second set of protrusions.

FIG. 32 is a perspective view of a housing 1400, according to some embodiments. The housing includes a housing bore 1402. The housing defines an input aperture 1404. The input aperture can optionally include a seal such as a lip seal. Other seals are possible.

The housing includes fasteners 1406. In some embodiments, these are female threaded aperture, but additional embodiments are configured otherwise. In some embodiments, the housing itself is threaded and a lid screws onto it. The housing can optionally include studs. In some embodiments, the housing is sealed by adhering a lid to the housing.

Channels 1408 are illustrated. In various embodiments, these are to lessen the rotating mass of the housing. The channels are optional, and other structures can be coupled to or defined by the housing, such as mounting ears, support legs for the housing, and other options. In one embodiment, a handle is coupled to the housing so that an operator can manipulate the housing.

FIG. 33A is a perspective view of an input 1500, according to some embodiments. The input includes an input interface 1502. In some examples this is a female socket form such as is used commonly in hand tools. In further embodiments, the input interface includes a shear pin that can limit the amount of torque that is applied to the input.

The input can optionally include channels 1504 that can lighten the rotating mass of the input 1500. These channels can also be sized to function as an oil reservoir. In some embodiments, a channel edge 1506 functions to wipe oil around a housing bore to lubricate the housing bore. The input shaft 1510 is rotably disposed through a housing in various embodiments. It includes a centerline 1512.

FIG. 33B is a further perspective view of an input 1500, according to some embodiments. The input 1500 defines an input bore 1508 that has a centerline 1514 that is offset from the centerline 1512 of the input interface. In various embodiments, the exterior portion of the input 1500 that is to spin in a housing has a radius dimension R51. In various embodiments, the input bore 1508 has a radius dimension R52. The offset is defined in part by thickness dimensions 1516 and 1518. These dimensions are disposed 180 degrees from each other with respect to centerline 1512. Accordingly, as the input spins in a housing, the input bore 1508 oscillates. The offset of an input centerline 1512, and the diameter of an input bore can be varied to provide for a range of optional input/output ratios.

FIG. 34A is a perspective view of a carrier 1600, according to some embodiments. The carrier 1600 has a external radius dimension R61 that is sized to fit in an input bore. The illustration shows 9 sockets 1602 sized to receive rollers. Eight sockets 1618 are also illustrated. The sockets 1602 and 1618 are like sized, but the present subject matter is not so limited. Although the sockets are circular, other shapes are possible. Rollers can be set in the sockets radially along a direction perpendicular to the centerline 1604 of the carrier. In optional embodiments, the sockets 1602 can conform to the rollers leaving an opening that is less wide than the diameter of the roller, such that the rollers are installed along a direction parallel to the centerline 1604.

The sockets 1602 are arranged annularly around pitch circle 1614 which has a dimension of R63. The sockets 1618 are arranged annularly around pitch circle 1616 which has a dimension of R64. The input/output ratio is a speed ratio and a torque ratio.

Various embodiments include a carrier channel 1606 that can be supported by bearings and that can optionally contain oil. The carrier channel 606 is useful to support and resist motion in a direction parallel the centerline 1604.

The carrier defines a carrier interior, cavity or hollow 1608 along which two sets 1610, 1612 of sockets are arrange in annularly, with the sockets arranged equidistant from one another. The carrier hollow 1608 has a radius dimension R62.

FIG. 34B is a further perspective view of a carrier 1600, according to some embodiments. The illustration shows 8 sockets 1618. Accordingly, the carrier provides for an input/output ratio other than a 1:1 ratio in use. The number and size of rollers can be adjusted to produce various input/output ratios. Further, the pitch circle of rollers to confront a housing pinion can be changed to differ from a pitch circle of rollers to confront an output pinion.

FIG. 35 is a perspective view of rollers 1700 to be disposed in sockets of a carrier, according to some embodiments. Some rollers can include hollow centers to lessen their mass in use. This can provide for increase speed of response of a transmission. The illustrated rollers have a beveled edge 1702, but the present subject matter is not so limited. The rollers are arranged in an annular configuration in use. Each of the rollers has a center axis 1704 that is generally parallel to the carriers center axis. Some or all of the rollers have a core 1706 removed to save weight. In various embodiments the rollers each have a diameter D71. In various embodiments this is 5/16 of an inch, but other sizes are possible.

FIG. 36 illustrates a perspective view of an output 1802 and an optional coupler 1804, according to some embodiments. The output coupler includes an output interface 1806. This is a male socket commonly used in hand tools, but the present subject matter is not so limited and other types of interfaces are possible. The coupler 1804 is coupled to the output 1802 via a shear pin 1808. The shear pin 1808 is designed to shear at a specified torque. This is so that a transmission in use is not subjected to a torque above a desired level.

The output pinion 1810 includes cam lobes. The number of lobes is one less than the number of protrusions of a carrier that is to confront and mesh with the output pinion 1810. An example cam lobe 1814 has a center 1812 that lies on a centerline 1816. In various embodiments, the cam lobe 1814 has a surface 1818 that is at least partially circular with respect to the center 1812. In various embodiments, the cam surface is defined by equations 1-3.

$$\begin{matrix}X = cos ( α ) * ( {R}_{81} + ( \frac{{D}_{71}}{2} ) - Offset ) & ( 1 ) \\ Y = sin ( α ) * ( {R}_{81} + ( \frac{{D}_{71}}{2} ) - Offset ) & ( 2 ) \\ Offset = ( \frac{{D}_{71}}{4} ) & ( 3 )\end{matrix}$$

The equations provide one X and one Y coordinate per inputted angle measurement (in radians). An example of a roller is provided in FIG. 35. The centerline 1816 has a radius dimension R81 of approximately 1.625 inches in some embodiments. Although the cam lobes approximate a sinusoidal curve, the present subject matter is not so limited. Reliefs can be cut so that more or fewer protrusions can be included. For example gear teeth with reliefs for meshing gears can be included according to standard gear design.

FIG. 37 illustrates a perspective view of a lid 1900 for housing and a housing pinion, according to some embodiments. The lid 1900 includes a plurality of bores 904 that reduce the mass of the lid 1900. A number of fasteners ports are included. These are pass throughs for bolts that are to bolt to a housing. A lid interface 1906 is provided so that a user can apply a torque to a transmission, which is useful during installation. The interface 1906 is shaped like a hex nut in some embodiments, although other shapes, such as shapes having two or three ears, are possible.

A housing pinion 1902 is illustrated. An example cam lobe 1912 has a center 1914 that lies on a centerline 1916. In various embodiments, the cam lobe 1912 has a surface 1918 that is at least partially circular with respect to the center 1914. The centerline 1916 has a radius dimension R91. Although the cam lobes approximate a sinusoidal curve, the present subject matter is not so limited. Reliefs can be cut so that more or fewer protrusions can be included. For example gear teeth with reliefs for meshing gears can be included according to standard gear design.

The pinion 1902 and the lid 1900 define an output aperture 1908 through which an output can extend. The output can be sealed to the output aperture 1908 in various embodiments. Shims are optionally used to control the depth of the housing bore with respect to the lid in some embodiments so that roller bearing sets can be used and appropriately preloaded.

FIG. 38 is a perspective view of a cross section of a bearing system 11000 to be installed in a transmission, according to some embodiments. These are provided in an exploded view. Bearing 11002 is to be disposed between an input and a housing. Bearing 11004 is to be disposed between an input and a carrier. Bearing 11006 is to be disposed between a carrier and a housing. Bearing 11010 is to be disposed between a carrier and a housing. Bearing 11012 is disposed between an input and a housing. Bearing 11014 is to be disposed between and output and a lid and includes an optional lip 105 to constrain axial forces on the output. Bearings 11016 and 11018 are to be disposed between a lid and a carrier. Sleeve shaped bearings can include IGUS iglide® T500 material, but the present subject matter is not so limited. Thrust bearings can include IGUS iglidur® G—type T material, but the present subject matter is not so limited. Other materials are possible without departing from the present scope.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. Apparatus, comprising:
a housing having a housing bore with a housing bore centerline;
an input rotably disposed in the bore, the input having an input bore that is offset from the housing bore;
a carrier rotably disposed in the input bore, the carrier defining a cavity with a first and second set of protrusions extending into the cavity, each set located along a pitch circle that is substantially perpendicular to the housing bore centerline;
a housing pinion coupled to the housing, the housing pinion disposed at least partially in the carrier to, when a rotational force is applied to the input, engage the first set of protrusions such that a protrusion of the housing pinion moves along a first hypocycloidal path with respect to the carrier and in phase with the carrier; and
an output including an output pinion disposed at least partially in the carrier to, when the rotational force is applied to the input, engage the second set of protrusions such that a protrusion of the output pinion moves along a second hypocycloidal path with respect to the carrier and in phase with the carrier.

2. The apparatus of claim 1, wherein the first set of protrusions includes cam lobes, and the housing pinion includes cam lobes to mesh with the cam lobes of the first set of protrusions.

3. The apparatus of claim 2, wherein the second set of protrusions includes cam lobes, and the output pinion includes cam lobes to mesh with the cam lobes of the second set of protrusions.

4. The apparatus of claim 1, wherein each protrusion of the first and second sets of protrusions includes a roller rotably disposed in socket of the carrier.

5. The apparatus of claim 1, wherein the first set of protrusions includes 9 protrusions equidistant from one another and the pinion includes 8 protrusions equidistant from one another to engage the first set of protrusions.

6. The apparatus of claim 5, wherein the second set of protrusions equidistant from one another includes 8 protrusions equidistant from one another and the output pinion includes 7 protrusions equidistant from one another to engage the second set of protrusions.

7. The apparatus of claim 1, further comprising means for transmitting the rotational force when it is applied to the input and for braking the rotational force applied to the output.

8. The apparatus of claim 1, wherein the first set of protrusions includes gear teeth, and the housing pinion includes gear teeth to mesh with the gear teeth of the first set of protrusions.

9. The apparatus of claim 8, wherein the second set of protrusions includes gear teeth, and the output pinion includes gear teeth to mesh with the gear teeth of the second set of protrusions.

10. A transmission assembly, comprising:
a first transmission comprising:
an input;
a transmission body housing a torque transmitter coupled to the input to transmit a torque applied to the input; and
an output coupled to the torque transmitter to further transmit the torque, and
a second transmission coupled to the first transmission to restrict rotation of the output when a backdrive torque is applied to the output, the second transmission comprising:
a housing having a housing bore with a housing bore centerline;
a second input coupled to the output of the first transmission, the second input rotably disposed in the bore, the input having an input bore that is offset from the housing bore, the input also including an input interface to couple to a coupling;
a carrier rotably disposed in the input bore, the carrier defining a cavity and including a first and second set of protrusions that extend into the cavity, each set located along a pitch circle that is substantially perpendicular to the housing bore centerline;
a housing pinion coupled to the housing, the housing pinion disposed at least partially in the carrier to engage the first set of protrusions such that a protrusion of the housing pinion moves along a first hypocycloidal path with respect to the carrier and in phase with the carrier when a rotational force is applied to the input; and
a second output including an output interface and an output pinion disposed at least partially in the carrier to engage the second set of protrusions such that a protrusion of the output pinion moves along a second hypocycloidal path with respect to the carrier and in phase with the carrier when the rotational force is applied to the input.

11. The assembly of claim 10, wherein the first set of protrusions define cam lobes, and the housing pinion defines cam lobes to mesh with the cam lobes of the first set of protrusions.

12. The assembly of claim 11, wherein the second set of protrusions define cam lobes, and the output pinion defines cam lobes to mesh with the cam lobes of the second set of protrusions.

13. The assembly of claim 10, wherein each protrusion of the first and second sets of protrusions includes a roller interference fit in a socket of the carrier.

14. The assembly of claim 10, wherein each of the first set of protrusions abuts the housing pinion.

15. The assembly of claim 10, wherein each of the second set of protrusions abuts the output pinion.

16. The assembly of claim 10, wherein the carrier, housing pinion and output pinions are sealed into the housing by a housing lid, with the output interface sealably extending through the housing lid, and with input interface sealably extending through the housing.

17. Apparatus, comprising:
a housing having a housing bore with a housing bore centerline;
an input rotably disposed in the bore, the input having an input bore that is offset from the housing bore, the input also including an input interface to couple to a coupling;
means for rotating in the input bore;
means, coupled to the housing, for imparting rotation onto the means for rotating in the input bore when a torque is applied to the input; and
means for outputting torque while the means for imparting rotation on the means for rotating is imparting the rotation,
wherein the means for rotating, the means for imparting rotation onto the means for rotating, and the means for outputting torque restrict rotation when rotational force is applied to the means for outputting torque.

18. The apparatus of claim 17, wherein the means for rotating include a carrier rotably disposed in the input bore, the carrier including a first and second set of protrusions that are inwardly extending, each set located along a pitch circle that is substantially perpendicular to the housing bore centerline.

19. The apparatus of claim 18, wherein the means for imparting rotation onto the means for rotating include a housing pinion coupled to the housing, the housing pinion disposed at least partially in the carrier to, when a rotational force is applied to the input, engage the first set of protrusions such that the housing pinion moves along a first hypocycloidal path with respect to the carrier and in phase with the carrier.

20. The apparatus of claim 19, wherein the means for outputting torque include an output including an output interface and an output pinion disposed at least partially in the carrier to, when the rotational force is applied to the input, engage the second set of protrusions such that the output pinion moves along a second hypocycloidal path with respect to the carrier and in phase with the carrier.

21. (canceled)

22. (canceled)

23. (canceled)

24. (canceled)
